(19) United States
(12) Patent Application Publication
(10) Pub. No.: US 2026/0141590 A1
(43) Pub. Date: May 21, 2026

(54) SYSTEMS AND METHODS FOR GENERATING A COMBINED IMAGE

(71) Applicant: ADOBE INC., SAN JOSE, CA (US)

(72) Inventors: Yufan Zhou, Santa Clara, CA (US); Ruiyi Zhang, Palo Alto, CA (US); Nanxuan Zhao, San Jose, CA (US); Jiuxiang Gu, Redmond, WA (US); Zichao Wang, San Jose, CA (US); Tong Sun, San Ramon, CA (US)

(21) Appl. No.: 18/948,943

(22) Filed: Nov. 15, 2024

(51) Int. Cl. G06T 11/60

(52) U.S. Cl. CPC G06T 11/60

(57) ABSTRACT

A method, apparatus, non-transitory computer readable medium, and system for image generation include obtaining a detail image and a style image, where the detail image depicts an image element and the style image depicts a style element. A combined image embedding is generated that includes a detail embedding patch and a style embedding patch based on the detail image and the style image, where the detail embedding patch represents the image element and the style embedding patch represents the style element. An image refinement model generates a combined image based on the combined image embedding. The combined image depicts the image element from the detail image and the style element from the style image.

### BACKGROUND

The following relates generally to image generation, and more specifically to image generation using machine learning. Machine learning algorithms build a model based on sample data, known as training data, to make a prediction or a decision in response to an input without being explicitly programmed to do so.

One area of application for machine learning is image generation. For example, machine learning models may be used to generate a single image output based on multiple input images.

### SUMMARY

Systems and methods are described for generating a combined image by applying a style element depicted in a style image to an input image. In some embodiments, the input image depicts a first object, and a style image depicts a second object that is similar to the first object but that differs in some fine-grained details. In some embodiments, a combined representation of the input image and the style image is generated, and the stylized image is generated based on the combined representation. Because the stylized image is generated based on the combined representation, the stylized image accurately depicts the fine-grained details of the first object and the style element depicted by the style image.

According to some embodiments, the method includes obtaining a detail image and a style image, wherein the detail image depicts an image element and the style image depicts a style element; generating a combined image embedding including a detail embedding patch and a style embedding patch based on the detail image and the style image, wherein the detail embedding patch represents the image element and the style embedding patch represents the style element; and generating, using an image refinement model, a combined image based on the combined image embedding, wherein the combined image depicts the image element from the detail image and the style element from the style image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of an image generation system according to aspects of the present disclosure.

FIG. 2 shows an example of a method for generating a combined image according to aspects of the present disclosure.

FIG. 3 shows an example of an image generation system for generating a combined image according to aspects of the present disclosure.

FIG. 4 shows an example of an image generation system for generating a style image according to aspects of the present disclosure.

FIG. 5 shows an example of a detail image, a corresponding set of style images, and a corresponding set of combined images according to aspects of the present disclosure.

FIG. 6 shows an example of an image generation system for generating a revised image according to aspects of the present disclosure.

FIG. 7 shows an example of synthetic images generated by a trained image generation model according to aspects of the present disclosure.

FIG. 8 shows an example of synthetic images having pose or view changes generated by a trained image generation model according to aspects of the present disclosure.

FIG. 9 shows an example of edited images generated by a trained image generation model according to aspects of the present disclosure.

FIG. 10 shows an example of a guided diffusion model according to aspects of the present disclosure.

FIG. 11 shows an example of a U-Net according to aspects of the present disclosure.

FIG. 12 shows an example of a method for generating a combined image based on a combined image embedding according to aspects of the present disclosure.

FIG. 13 shows an example of a method for computing a combined image embedding including a combined patch embedding according to aspects of the present disclosure.

FIG. 14 shows an example of a method for conditional image generation according to aspects of the present disclosure.

FIG. 15 shows an example of a diffusion process according to aspects of the present disclosure.

FIG. 16 shows an example of a flow diagram depicting an algorithm as a step-by-step procedure for training a machine learning model according to aspects of the present disclosure.

FIG. 17 shows an example of a method for training a diffusion model according to aspects of the present disclosure.

FIG. 18 shows an example of an image generation system for training an image refinement model according to aspects of the present disclosure.

FIG. 19 shows an example of an image generation system for training a view generation model according to aspects of the present disclosure.

FIG. 20 shows an example of an image generation system for training an image generation model to perform image editing according to aspects of the present disclosure.

FIG. 21 shows an example of an image generation system for training an image generation model to perform image generation according to aspects of the present disclosure.

FIG. 22 shows an example of an image generation system for training an image generation model to perform image generation with pose or view change according to aspects of the present disclosure.

FIG. 23 shows an example of a taxonomy of an image generation model training set according to aspects of the present disclosure.

FIG. 24 shows an example of a computing device according to aspects of the present disclosure.

FIG. 25 shows an example of an image generation apparatus according to aspects of the present disclosure.

### DETAILED DESCRIPTION

### Overview

The following relates to image generation using machine learning. Machine learning models may be used to generate a single image output based on multiple input images. However, given an input pair of images in which a first image depicts an object, and a second image depicts a corresponding object and a style element, conventional machine learning models do not accurately generate an output image that depicts the object of the first image and the style element of the second image.

Accordingly, aspects of the present disclosure generate a combined image based on a combined image embedding generated based on a detail image and a style image. In some embodiments, the detail image and the style image are encoded to obtain a detail image embedding and a style image embedding, respectively. The detail image includes a first patch depicting an image element and the style image includes a second patch depicting a corresponding image element and a third patch depicting a style element. In some embodiments, the combined image embedding includes a detail embedding patch generated based on a similarity between the image element and the corresponding image element, and a style embedding patch representing the style element. The combined image generated based on the combined image embedding therefore accurately depicts the image element from the detail image and the style element from the style image.

An example image generation system according to the present disclosure is used in an image generation context. In the example, a user provides a detail image depicting a dog and a text prompt “in red” describing a style element to the image generation system. The image generation system uses a machine learning model to generate a style image based on the detail image and the text prompt, where the style image depicts a visibly different dog in red.

The image generation system uses another machine learning model to generate a combined image based on selected portions of embeddings of the detail image and the style image, such that the combined image depicts the dog from the detail image with the “in red” style of the style image. The image generation system is therefore able to provide a stylized image that maintains fine-grained subject details from the detail image while also maintaining a text-image alignment with the text prompt.

Furthermore, in some embodiments, the detail image, the text prompt, and the combined image can be used as training data to train an image generation model to accurately and efficiently generate stylized images based on a text prompt and an input image.

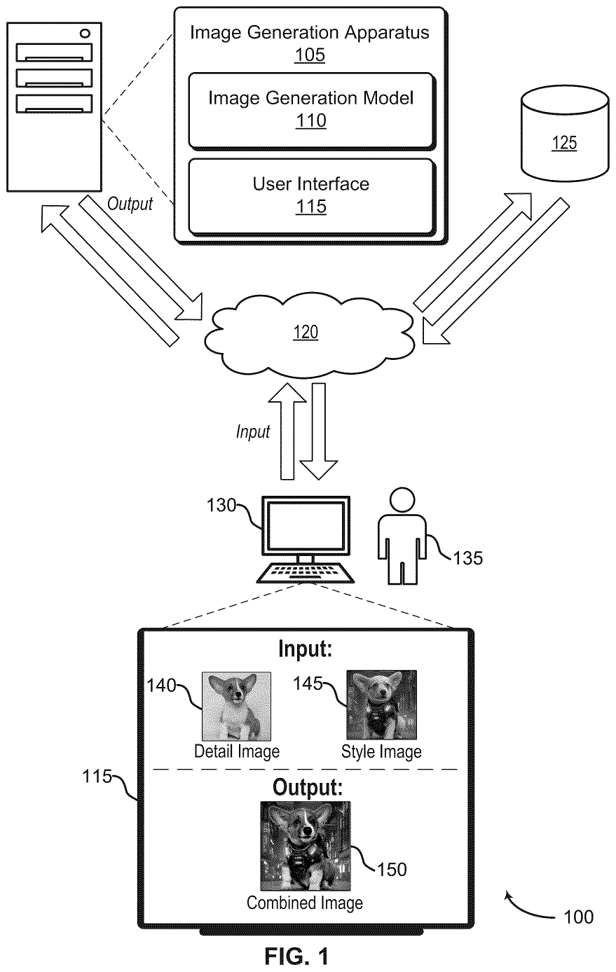

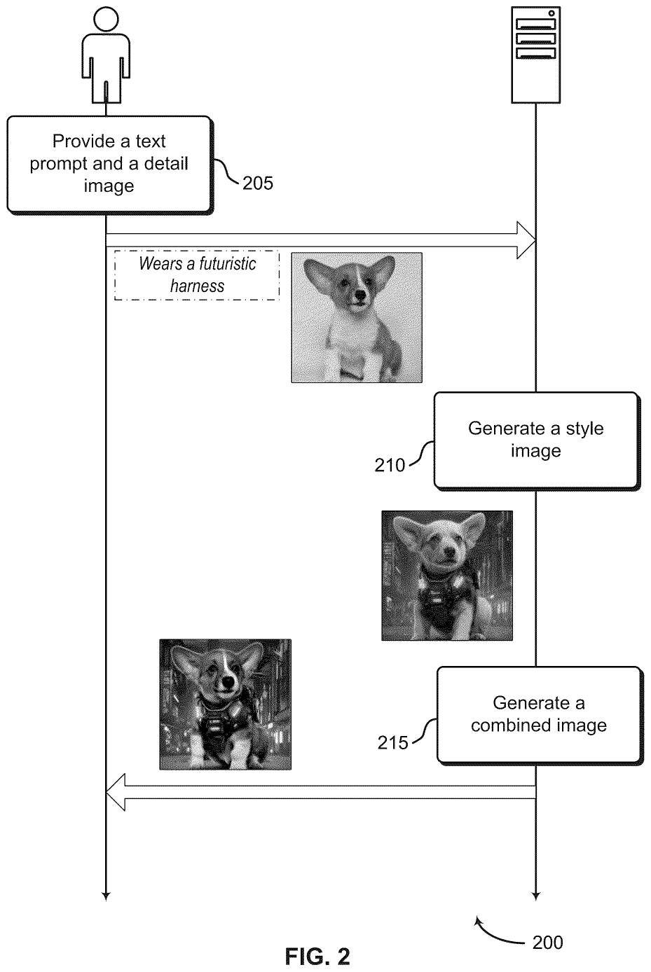

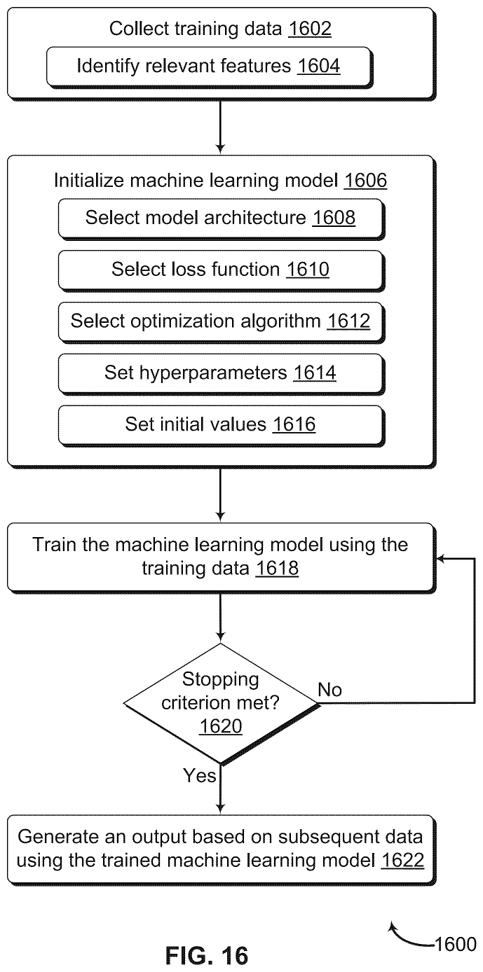

Further example applications of the present disclosure in an image generation context are provided with reference to FIGS. 1-2. Details regarding the architecture of an image generation system are provided with reference to FIGS. 1, 3-11, and 18-25. Examples of a process for generating a combined image are provided with reference to FIGS. 2 and 12-15. Examples of a process for training a machine learning model are provided with reference to FIGS. 16-23.

Embodiments of the present disclosure improve upon conventional image generation systems by making an image combination process more accurate. For example, some embodiments achieve this accuracy by generating a combined image based on a combined image representation that includes embedding patches selected from a detail image and a style image, respectively, such that the combined image representation represents a detail element from the detail image and a style element from the style image. The combined image generated based on the combined image embedding therefore accurately depicts the image element from the detail image and the style element from the style image.

Furthermore, embodiments of the present disclosure improve upon conventional image generation systems by efficiently generating a training set for training an image generation model to perform text-based image editing and generation. For example, some embodiments achieve this efficiency by generating a combined image as a training target image based on a detail image and a style image. Accordingly, embodiments of the present disclosure use one trained machine learning model to generate training target images.

By contrast, a conventional image generation system fine-tunes a text-to-image generation model on each subject image and uses the specifically fine-tuned model to generate a training target image for the subject image. In other words, to construct a dataset including N subjects, the conventional image generation system uses O (N) fine-tuning steps, while an image generation system according to at least one aspect of the present disclosure uses O (1) fine-tuning steps.

### Image Generation System

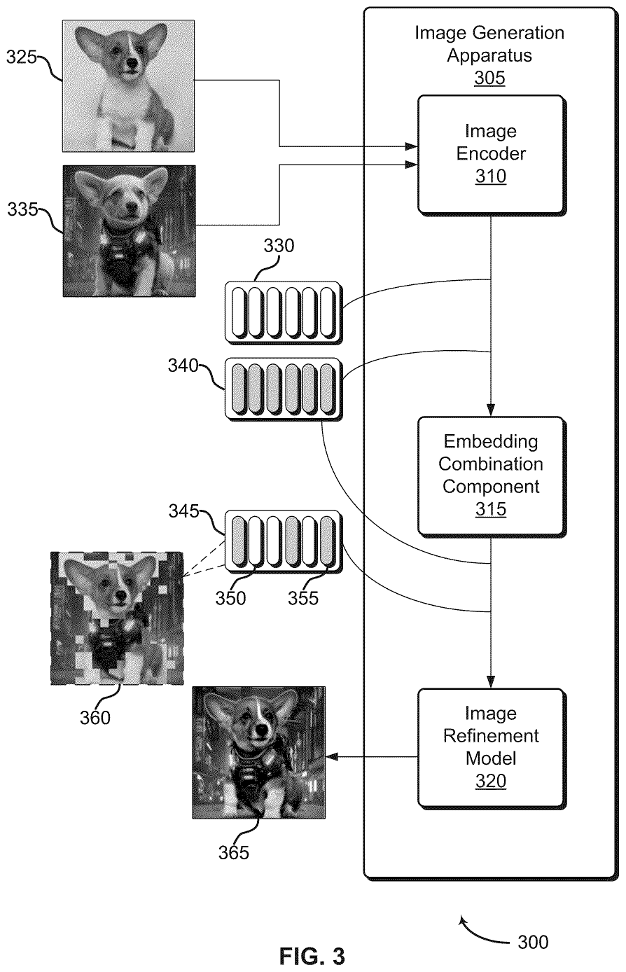

FIG. 1 shows an example of an image generation system 100 according to aspects of the present disclosure. The example shown includes image generation system 100, user device 130, user 135, detail image 140, style image 145, and combined image 150. Image generation system 100 is an example of, or includes aspects of, the corresponding element described with reference to FIGS. 3, 4, 6, and 18-22. In one aspect, image generation system 100 includes image generation apparatus 105, cloud 120, and database 125. In one aspect, image generation apparatus 105 includes image refinement model 110 and user interface 115.

Referring to FIG. 1, image generation apparatus 105 obtains a detail image (e.g., detail image 140) and a style image (e.g., style image 145). In an example, user 135 provides the detail image and the style image to image generation apparatus 105 via user interface 115 provided on user device 130 by image generation apparatus 105.

The detail image includes a first region depicting an image element, and the style image includes a second region depicting a corresponding image element and a third region depicting a style element. For example, detail image 140 depicts a dog (an image element) in a first region, and style image 145 depicts a similarly posed but different dog (a corresponding element) in a second region, with a futuristic cityscape and dog harness (a style element) in a third region.

Image generation apparatus 105 generates a combined image embedding including a detail embedding patch and a style embedding patch based on the detail image and the style image. The detail embedding patch corresponds to the second region of the style image and represents the image element from the first region of the detail image based on a similarity between the image element and the corresponding image element. The style embedding patch corresponds to the third region of the style image and represents the style element.

Image refinement model 110 generates a combined image (e.g., combined image 155) based on the combined image embedding. The combined image depicts the image element from the first region of the detail image and the style element from the third region of the style image. For example, combined image 150 depicts the dog from detail image 140 with the futuristic cityscape and dog harness from style image 145. Image generation apparatus 105 provides the combined image to user 135 via user interface 115 and user device 130.

A “detail image” refers to an image depicting an image element. An image element refers to an object or objects depicted in an image. A “region” refers to one or more pixels of an image. A “style image” refers to an image depicting a corresponding element and a style element.

A “corresponding element” is an image element corresponding to the image element depicted by the detail image. The corresponding element may correspond to the image element based on one or more common characteristics of both the corresponding element and the image element, such as a pose, an object shape, an object size, or an object class. A corresponding element may differ from the image element based on a fine-grained detail included in the image element and not included in the corresponding element. For example, detail image 140 depicts a particular dog that is identifiable as the particular dog based on fine-grained details such as facial structure, fur color, and bodily proportions that are independent of a pose or view of the dog, while style image 145 depicts a different dog having different fine-grained details.

A “style element” refers to an object or characteristic depicted by a style image. For example, style image 145 depicts a futuristic cityscape and dog harness as a style element. Another examples of a style elements is an image done in a line-drawing style, where the line-drawing style is the style element. A style element may be described by a text prompt.

An “embedding” refers to a representation of an object (e.g., an element) in a lower-dimensional space (an embedding space) such that semantic information about the object is more easily captured and analyzed by a machine learning model. For example, the embedding is a numerical representation of the object in a continuous vector space (the embedding space) in which objects that include similar semantic information to each other correspond to vectors that are numerically similar and thus “closer” to each other, thereby allowing a similarity between different objects corresponding to different embeddings to be readily determined. An “embedding space” (or a “vector space”) refers to a mathematical set having embeddings (or vectors) as components and is characterized by a dimension specifying a number of independent directions in the embedding space.

In some embodiments, an “embedding patch” refers to a portion of an embedding. In some embodiments, the embedding patch is one vector of a sequence of vectors. In some embodiments, an embedding patch represents an image patch (e.g., a region of an image).

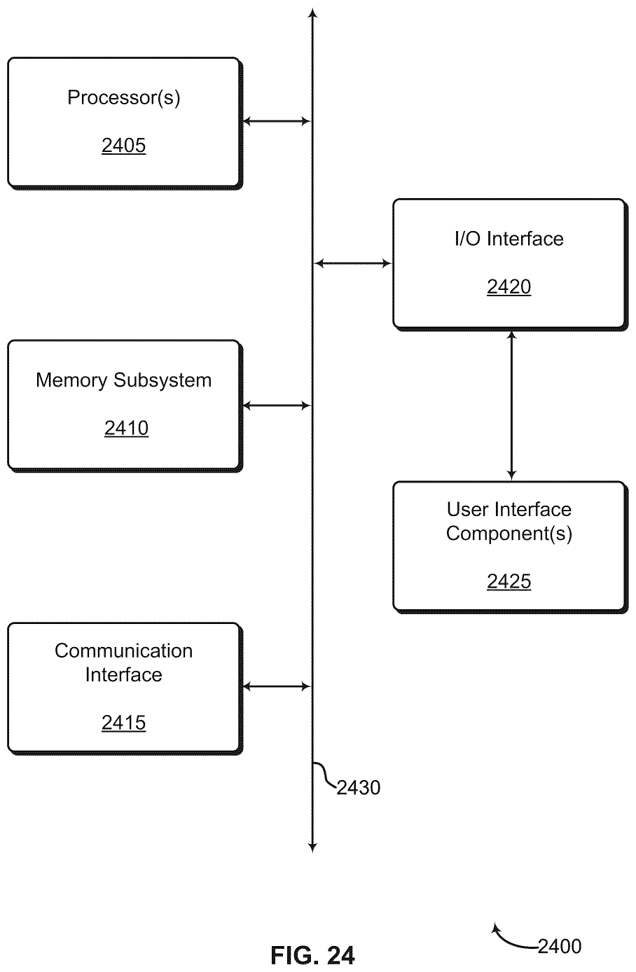

Image generation apparatus 105 is an example of, or includes aspects of, the corresponding element described with reference to FIGS. 3, 4, 6, 18-22, and 24-25. According to some aspects, image generation apparatus 105 includes a computer-implemented network. In some embodiments, the computer-implemented network includes a machine learning model (such as image refinement model 110, described in further detail with reference to FIGS. 3, 10-11, and 18). Image generation apparatus 105 may also include one or more processors, a memory subsystem, a communication interface, an I/O interface, one or more user interface components, and a bus as described with reference to FIG. 24. Additionally, image generation apparatus 105 may communicate with user device 130 and database 125 via cloud 120.

According to some aspects, image generation apparatus 105 is implemented on a server. A server provides one or more functions to users linked by way of one or more of various networks, such as cloud 120. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and/or simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

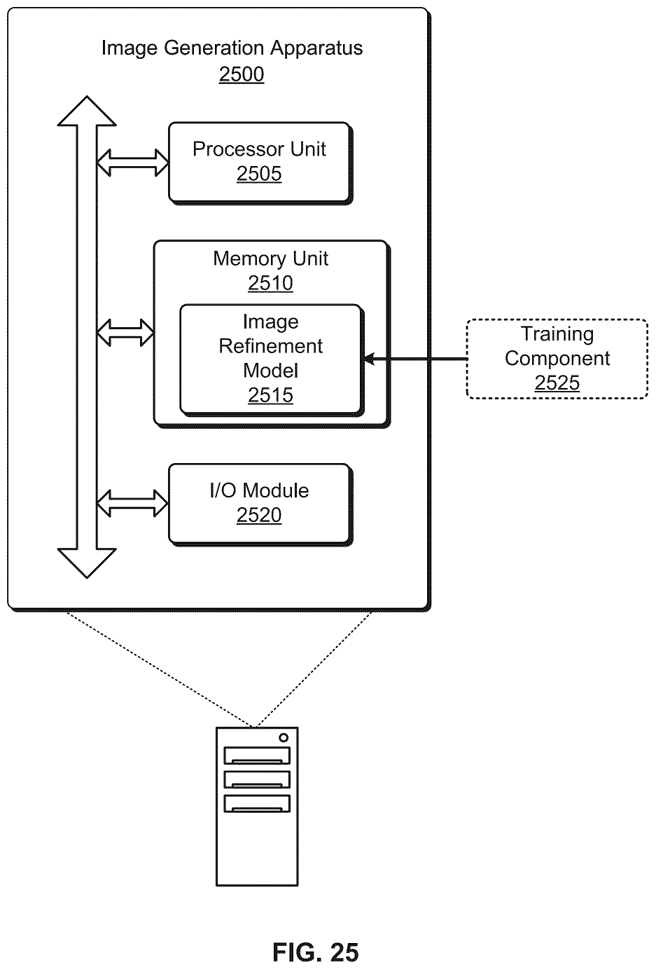

Image refinement model 110 is an example of, or includes aspects of, the corresponding element described with reference to FIGS. 3, 18, and 25. According to some aspects, image refinement model 110 comprises image refinement parameters (e.g., machine learning parameters) stored in the memory unit of image generation apparatus 105 (e.g., the memory unit 2510 described with reference to FIG. 25). According to some aspects, image refinement model comprises an artificial neural network (ANN) trained to generate a synthetic image based on an image embedding.

Further detail regarding the architecture of an image generation system is provided with reference to FIGS. 3-11 and 18-25. Further detail regarding an image generation process is provided with reference to FIGS. 2 and 12-15. Further detail regarding a process for training a machine learning model is provided with reference to FIGS. 16-23.

Cloud 120 is a computer network configured to provide on-demand availability of computer system resources, such as data storage and computing power. Cloud 120 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 120 may be limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communication between image generation apparatus 105, database 125, and user device 130.

Database 125 is an organized collection of data. In an example, database 125 stores data in a specified format known as a schema. According to some aspects, database 125 is structured as a single database, a distributed database, multiple distributed databases, or an emergency backup database. A database controller may manage data storage and processing in database 125. A user may interact with the database controller, or the database controller may operate automatically without interaction from the user. According to some aspects, database 125 is included in image generation apparatus 105. According to some aspects, database 125 is external to image generation apparatus 105 and communicates with image generation apparatus 105 via cloud 120.

According to some aspects, user device 130 is a personal computer, laptop computer, mainframe computer, palmtop computer, personal assistant, mobile device, or any other suitable processing apparatus. User device 130 may include software that displays user interface 115 (e.g., a graphical user interface) provided by image generation apparatus 105. The user interface 115 allows information (such as images, prompts, etc.) to be communicated between user 135 and image generation apparatus 105.

According to some aspects, a user device user interface enables user 135 to interact with user device 130. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

Detail image 140 is an example of, or includes aspects of, the corresponding element described with reference to FIGS. 3-6 and 19-21. Style image 145 is an example of, or includes aspects of, the corresponding element described with reference to FIGS. 3-5. Combined image 150 is an example of, or includes aspects of, the corresponding element described with reference to FIGS. 3, 5, and 20-22.

FIG. 2 shows an example of a method 200 for generating a combined image according to aspects of the present disclosure. Referring to FIG. 2, according to some aspects, an image generation system performs method 200 to generate a combined image based on a user-provided text prompt and detail image, where the text prompt describes a style element.

For example, the image generation system generates a style image based on the text prompt and the detail image. The style image depicts the style element described by the text prompt and a corresponding element that corresponds to an image element of the detail image. The image generation system then selects portions of embeddings of the style image and the detail image to obtain a combined image embedding. The image generation system then generates the combined image based on the combined image embedding, such that the combined image depicts the image element from the detail image and the style element from the style image. Accordingly, the image generation system provides a refinement of the style image and the detail image, such that both the subject of the detail image and a text-image alignment of the style image are maintained in the combined image.

At operation 205, the system provides a text prompt and a detail image. In some cases, the operations of this step refer to, or may be performed by, a user as described with reference to FIG. 1. For example, a user (such as the user 135 described with reference to FIG. 1) provides the text prompt and the detail image to the image generation system via a user interface (such as the user interface 115 described with reference to FIG. 1) provided on a user device (such as the user device 130 described with reference to FIG. 1) by an image generation apparatus of the image generation system (such as the image generation apparatus 105 described with reference to FIG. 1).

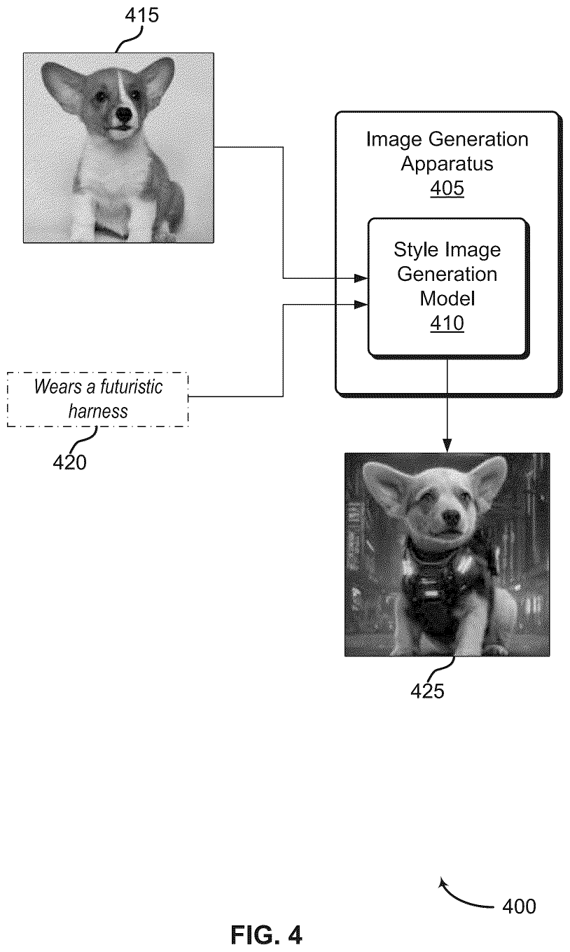

At operation 210, the system generates a style image. In some cases, the operations of this step refer to, or may be performed by, an image generation apparatus as described with reference to FIGS. 1, 3, 4, 6, 18-22, and 24-25. In an example, the image generation apparatus generates the style image based on the detail image and the text prompt as described with reference to FIG. 4.

At operation 215, the system generates a combined image. In some cases, the operations of this step refer to, or may be performed by, an image generation apparatus as described with reference to FIGS. 1, 3, 4, 6, 18-22, and 24-25. In an example, the image generation apparatus generates the combined image based on the detail image and the style image as described with reference to FIG. 3. The image generation apparatus provides the combined image to the user via the user interface.

FIG. 3 shows an example of an image generation system 300 for generating a combined image 365 according to aspects of the present disclosure. The example shown includes image generation system 300, detail image 325, detail image embedding 330, style image 335, style image embedding 340, combined embedding 345, combined embedding visualization 360, and combined image 365. In one aspect, image generation system 300 includes image generation apparatus 305. In one aspect, image generation apparatus 305 includes image encoder 310, embedding combination component 315, and image refinement model 320. In one aspect, combined embedding 345 includes detail embedding patch 350 and style embedding patch 355.

Referring to FIG. 3, according to some aspects, image encoder 310 encodes a detail image x (e.g., detail image 325) to obtain a detail image embedding f(x) (e.g., detail image embedding 330) and encodes a style image x′ (e.g., style image 335) to obtain a style image embedding f(x′) (e.g., style image embedding 340). In some embodiments, the detail image includes a first region depicting an image element. In the example of FIG. 3, a region of detail image 325 depicts a dog having fine-grained subject details (e.g., facial characteristics, anatomical shape and proportions, fur color, etc.) that correspond to a visible identity of the dog.

In some embodiments, the style image includes a second region depicting a corresponding image element. In the example of FIG. 3, a region of style image 335 depicts a dog having different fine-grained subject details than the dog of detail image 325, but with a similar outline shape and pose. In some embodiments, the style image includes a third region depicting a style element. In the example of FIG. 3, style image 335 includes a region depicting a futuristic cityscape and dog harness. In some embodiments, the style image is obtained as described with reference to FIG. 4.

According to some aspects, image encoder 310 divides the detail embedding and the style embedding into a set of detail embedding patches and a set of style embedding patches, respectively. In some embodiments, image encoder 310 divides each of the detail image embedding f(x) and the style image embedding f(x′) into a respective sequence of vectors, where f(x) denotes a j^{th} vector, or detail embedding patch (e.g., detail embedding patch 350), of the detail image embedding f(x) corresponding to a patch from the detail image (e.g., the first region), and where fᵢ(x′) denotes an i^{th} vector, or style embedding patch (e.g., style embedding patch 355), of the style image embedding f(x′) corresponding to one or more patches from the style image (e.g., the second region and the third region). In some embodiments, image encoder 310 embeds each patch of the detail image x and the style image x′ to obtain the detail image embedding f(x) and the style image embedding f(x′).

According to some aspects, embedding combination component 315 computes a set of similarity scores between the style embedding patch and the set of detail embedding patches, respectively. Embedding combination component 315 selects the detail embedding patch as corresponding to the style embedding patch based on the detail embedding patch having a highest similarity score among the set of similarity scores.

For example, for each style embedding patch in the style image embedding f(x′), embedding combination component 315 finds a most similar detail embedding patch eᵢ from the detail image embedding f(x) by patch embedding similarity:

$${e}_{i} = arg {max}_{j} Sim ( {f}_{j} ( x ) , {f}_{i} ( {x}^{′} ) ) \qquad ( 1 )$$

In Eq. 1, Sim stands for cosine similarity. In some examples, embedding combination component 315 computes a combined patch embedding rᵢ based on the detail embedding patch and the style embedding patch. In some embodiments, a combined image embedding r includes the combined patch embedding rᵢ at an index i of the style embedding patch fᵢ(x′). In an example, embedding combination component 315 obtains the combined image embedding r by performing linear combination between the style image embedding f(x′) and each most similar detail embedding patch eᵢ on highly similar patches:

$${r}_{i} = \{ \begin{matrix}α {e}_{i} + ( 1 - α ) {f}_{i} ( {x}^{′} ) , & if Sim ( {e}_{i} , {f}_{i} ( {x}^{′} ) ) \geq β \\ {f}_{i} ( {x}^{′} ) , & otherwise\end{matrix} \qquad ( 2 )$$

In Eq. 2, 0≤α≤1 and −1≤β≤1 are hyperparameters. Combined embedding visualization 360 is a representation in pixel space of combined embedding 345, including elements depicted in both detail image 325 and style image 335. Accordingly, image generation system 300 identifies corresponding patches between the detail image and the style image.

According to some aspects, image refinement model 320 generates a combined image (e.g., combined image 365) based on the combined image embedding. For example, in some embodiments, image refinement model 320 removes noise from a noisy Style image

$${x}_{t}^{′}$$

(or a noisy style image embedding

$$f ( {x}_{t}^{′} ) )$$

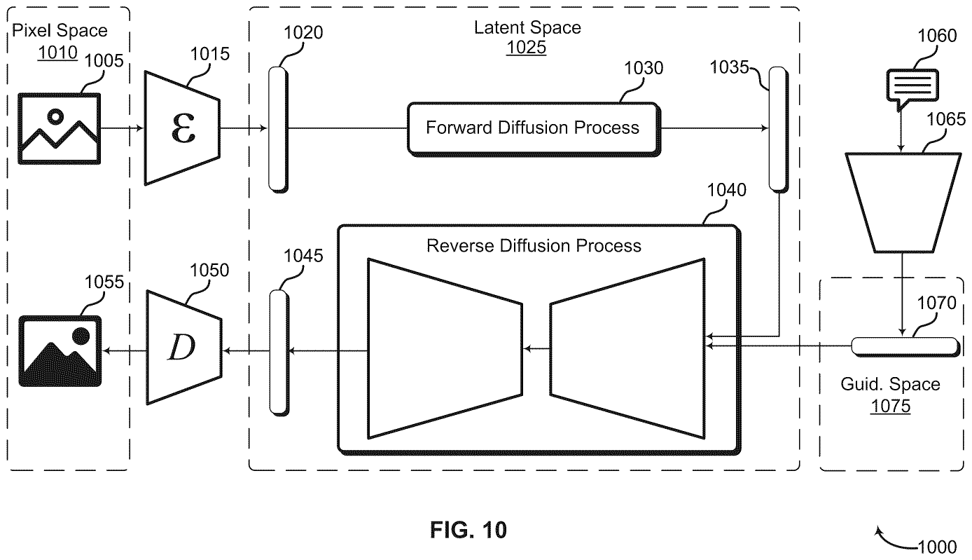

using a reverse diffusion process guided by the combined image embedding, where t<T, as described with reference to FIGS. 10 and 14-15.

In some embodiments, the combined image depicts the image element from the first region of the detail image and the style element from the third region of the style image. In the example of FIG. 3, combined image 365 depicts the dog from detail image 325 with the cityscape and futuristic harness from style image 335. Accordingly, combined image 365 harmonizes detail image 325 and style image 335 and depicts refines the identity of the dog depicted in style image 335 to the dog depicted in detail image 325.

According to some aspects, where the style image is obtained based on the detail image and a text prompt (e.g., as described with reference to FIG. 4), the combined image embedding provided by embedding combination component 315 accordingly allows image generation system 300 to stylize detail image according to the text prompt without a loss of text alignment (which may occur in the style image), and to maintain a desired difference between the detail image and the combined image in terms of style, color, texture, background, and other elements. Therefore, in some cases, the image generation system 300 refines subject details in low-quality image pairs (e.g., a detail image and a style image) to obtain a high-quality image pair (e.g., a detail image and a combined image) that features accurate text-image alignment in the combined image.

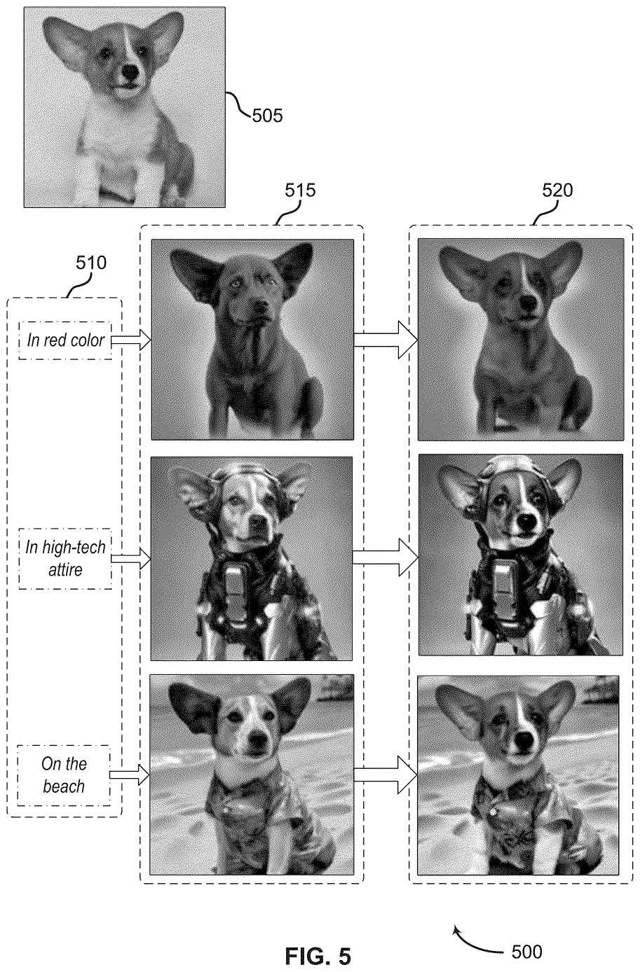

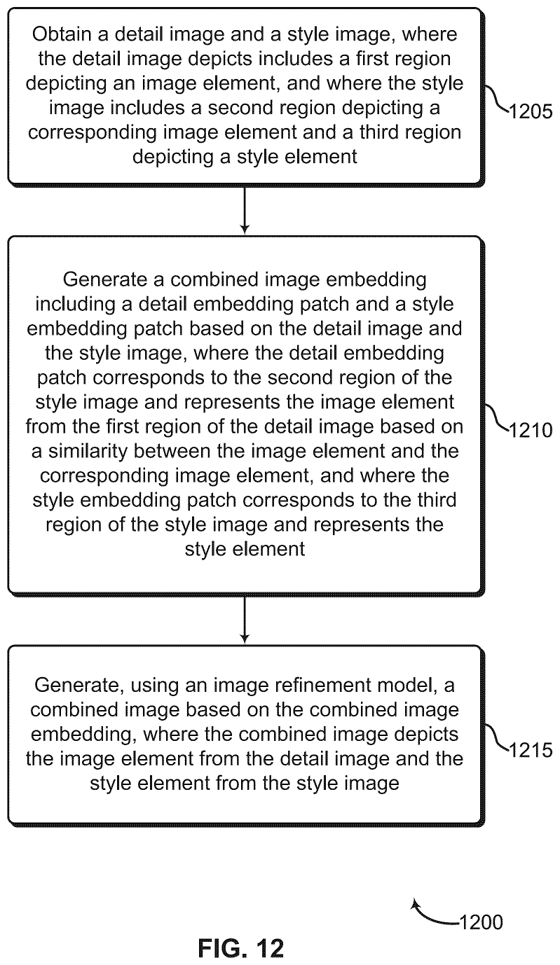

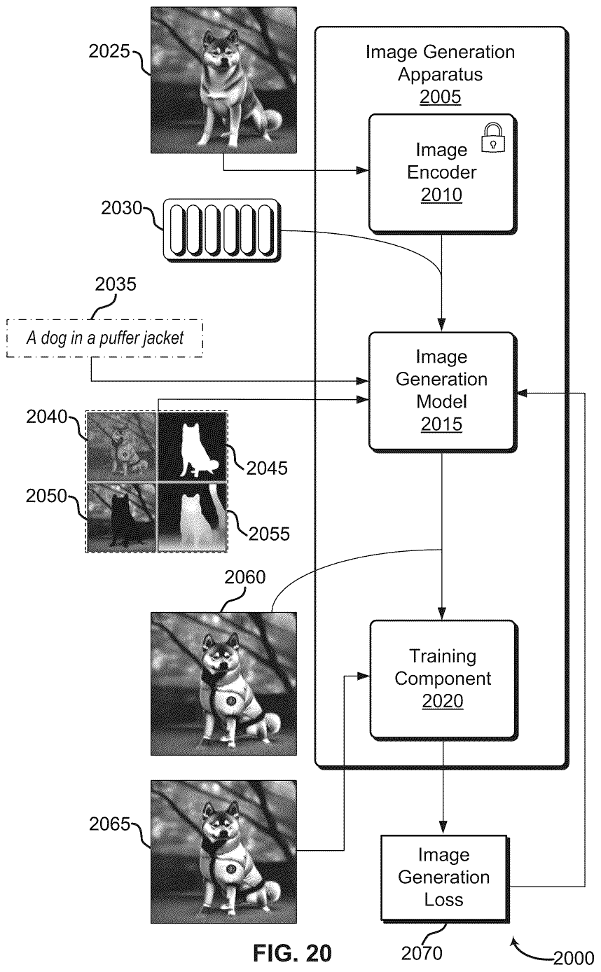

Further examples of the combined image are described with reference to FIG. 5. A process for generating the combined image is described with reference to FIG. 12. Further examples of a combined image as training data for an image generation model are described with reference to FIGS. 20-23.

Image generation system 300 is an example of, or includes aspects of, the corresponding element described with reference to FIGS. 1, 4, 6, and 18-22. Image generation apparatus 305 is an example of, or includes aspects of, the corresponding element described with reference to FIGS. 1, 4, 6, 18-22, and 24-25.

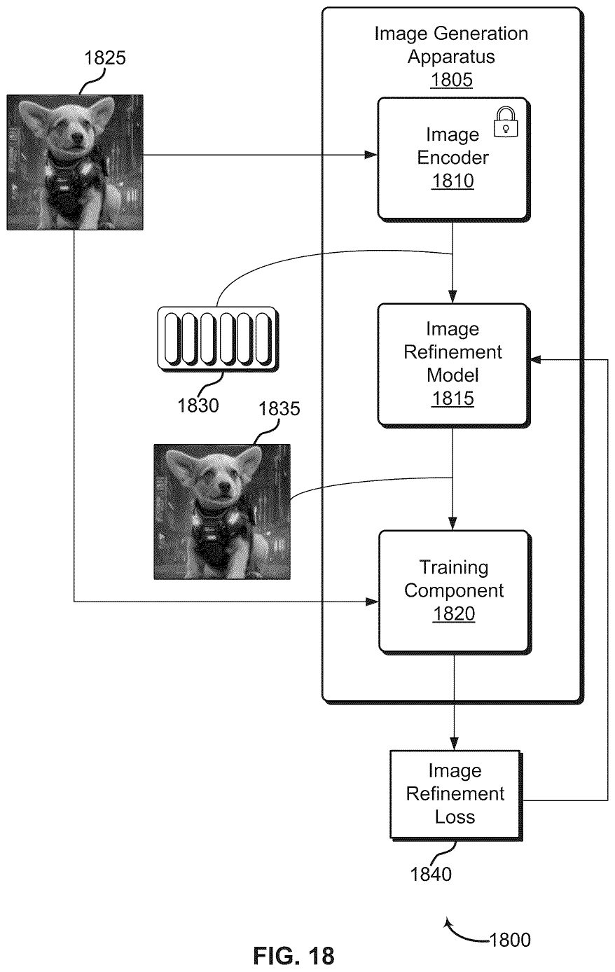

Image encoder 310 is an example of, or includes aspects of, the corresponding element described with reference to FIGS. 18-22. According to some aspects, image encoder 310 comprises image encoding parameters (e.g., machine learning parameters) stored in a memory unit of image generation apparatus 305 (such as the memory unit 2510 described with reference to FIG. 25). According to some aspects, image encoder 310 comprises an ANN trained to generate an image embedding based on an image. For example, in some embodiments, image encoder 310 comprises a convolutional neural network (CNN), a vision transformer (ViT), or other suitable ANN. According to some aspects, image encoder 310 comprises a distillation with no labels (DINO) encoder.

According to some aspects, embedding combination component 315 comprises executable code (e.g., software) stored in the memory unit of image generation apparatus 305, one or more hardware circuits included in image generation apparatus 305, firmware included in image generation apparatus 305, or a combination thereof.

Image refinement model 320 is an example of, or includes aspects of, the corresponding element described with reference to FIGS. 1, 18, and 25. According to some aspects, image refinement model 320 is trained as described with reference to FIG. 18.

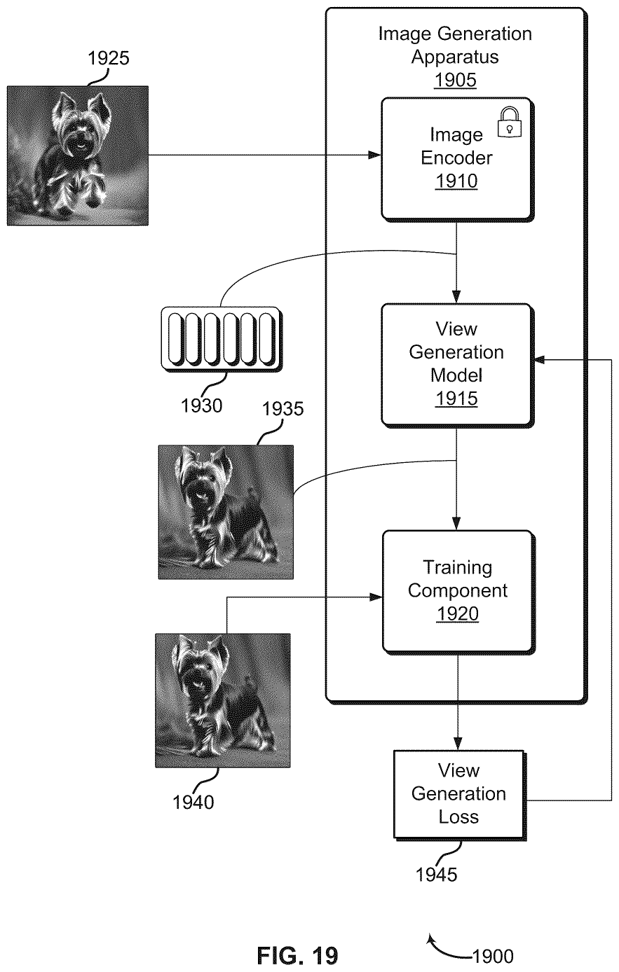

Detail image 325 is an example of, or includes aspects of, the corresponding element described with reference to FIGS. 1, 4-6, and 19-21. Detail image embedding 330 is an example of, or includes aspects of, the corresponding element described with reference to FIGS. 19-21. Style image 335 is an example of, or includes aspects of, the corresponding element described with reference to FIGS. 1, 4, and 5. Combined image 365 is an example of, or includes aspects of, the corresponding element described with reference to FIGS. 1, 5, and 20-22.

FIG. 4 shows an example of an image generation system 400 for generating a style image 425 according to aspects of the present disclosure. The example shown includes image generation system 400, detail image 415, text prompt 420, and style image 425. In one aspect, image generation system 400 includes image generation apparatus 405. In one aspect, image generation apparatus 405 includes style image generation model 410.

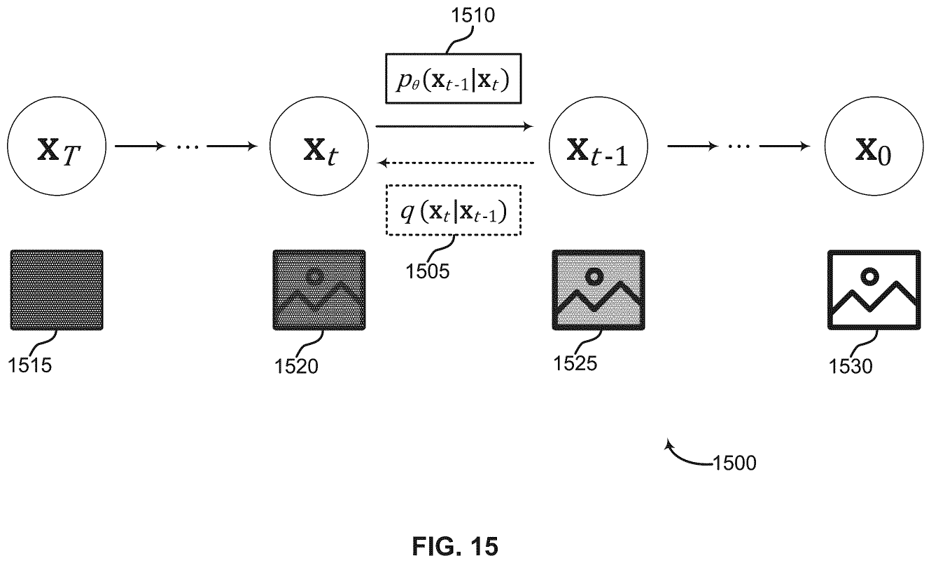

Referring to FIG. 4, according to some aspects, style image generation model 410 generates a style image (e.g., style image 425) based on a text prompt (e.g., text prompt 420, “Wears a futuristic harness”). In some aspects, the style image is generated based on a detail image (e.g., detail image 415). In an example, style image generation model 410 generates the style image by denoising a noisy detail image using the text prompt as guidance as described with reference to FIGS. 10 and 15.

In the example of FIG. 4, style image 425 depicts a dog wearing a futuristic harness. Style image 425 is generated based on detail image 415. However, style image 425 depicts a dog having different fine-grained subject details from the dog depicted in detail image 415. In some embodiments, style image generation model 410 generates the style image based on an editing mask for the detail image, such that only a non-masked region of the detail image is stylized in the style image.

Image generation system 400 is an example of, or includes aspects of, the corresponding element described with reference to FIGS. 1, 3, 6, and 18-22. Image generation apparatus 405 is an example of, or includes aspects of, the corresponding element described with reference to FIGS. 1, 3, 6, 18-22, and 24-25.

According to some aspects, style image generation model 410 comprises style image generation parameters (e.g., machine learning parameters) stored in a memory unit of image generation apparatus 405 (such as the memory unit 2510 described with reference to FIG. 25). According to some aspects, style image generation model 410 comprises an ANN trained to generate an image based on an image and/or text input. In an example, style image generation model 410 comprises a guided diffusion model, such as the guided diffusion model described with reference to FIG. 10.

Detail image 415 is an example of, or includes aspects of, the corresponding element described with reference to FIGS. 1, 3, 5, 6, and 19-21. Text prompt 420 is an example of, or includes aspects of, the corresponding element described with reference to FIGS. 5, 7-9, and 20-22. Style image 425 is an example of, or includes aspects of, the corresponding element described with reference to FIGS. 1, 3, and 5.

FIG. 5 shows an example 500 of a detail image, a corresponding set of style images, and a corresponding set of combined images according to aspects of the present disclosure. The example 500 shown includes detail image 505, set of text prompts 510, set of style images 515, and set of combined images 520.

Referring to FIG. 5, set of style images 515 are respectively generated based on detail image 505 and set of text prompts 510, and set of combined images 520 are respectively generated based on detail image 505 and set of style images 515. Set of style images 515 depict dogs having an unintentional change in fine-grained details from the dog depicted in detail image 505, while retaining a corresponding pose and view of the dog. By contrast, set of combined images 520 respectively depict the fine-grained details of the dog depicted in detail image 505 without a loss of text-image alignment from the corresponding set of text prompts 510 and set of style images 515.

Detail image 505 is an example of, or includes aspects of, the corresponding element described with reference to FIGS. 1, 3, 4, 6, and 19-21. Set of text prompts 510 is an example of, or includes aspects of, the corresponding element described with reference to FIGS. 1, 4, 7-9, and 20-22. Set of style images 515 is an example of, or includes aspects of, the corresponding element described with reference to FIGS. 1, 3, and 4. Set of combined images 520 is an example of, or includes aspects of, the corresponding element described with reference to FIGS. 1, 3, and 20-22.

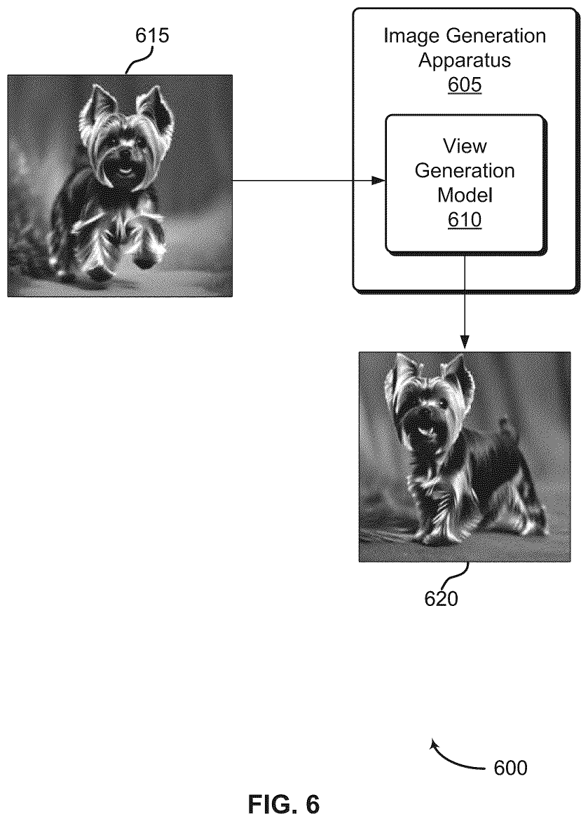

FIG. 6 shows an example of an image generation system 600 for generating a revised image according to aspects of the present disclosure. The example shown includes image generation system 600, detail image 615, and revised image 620. In one aspect, image generation system 600 includes image generation apparatus 605. In one aspect, image generation apparatus 605 includes view generation model 610.

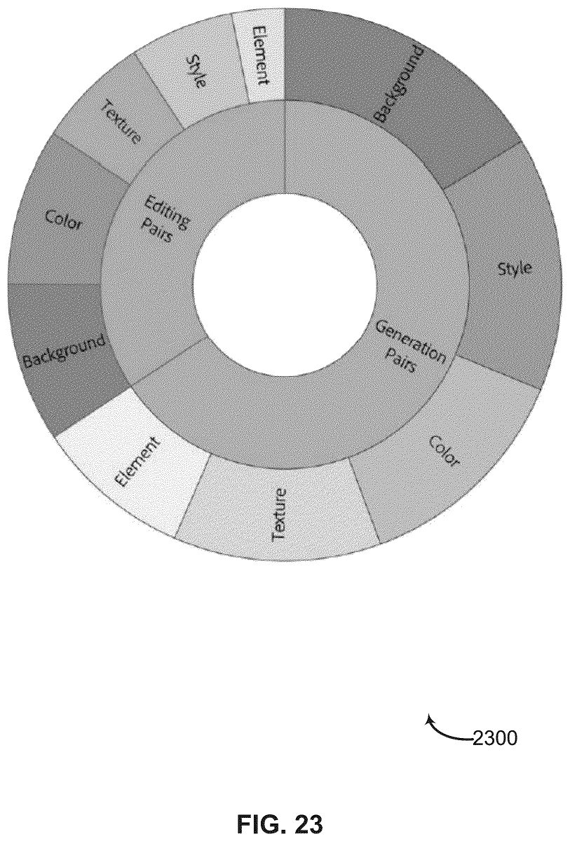

Referring to FIG. 6, according to some aspects, view generation model 610 generates a revised image (e.g., revised image 620) based on a detail image (e.g., detail image 615), where the revised image depicts the image element from a different view and/or with a different pose than the detail image. In the example of FIG. 6, detail image 615 depicts a dog having fine-grained subject details with a pose and from a particular view, while revised image 620 depicts the same dog having the fine-grained subject details with a different pose and from a different view. Further examples of a revised image as training data for an image generation model are described with reference to FIGS. 23 and 25.

Image generation system 600 is an example of, or includes aspects of, the corresponding element described with reference to FIGS. 1, 3, 4, and 18-22. Image generation apparatus 605 is an example of, or includes aspects of, the corresponding element described with reference to FIGS. 1, 3, 4, 18-22, and 24-25.

View generation model 610 is an example of, or includes aspects of, the corresponding element described with reference to FIG. 19. According to some aspects, view generation model 610 comprises view generation parameters (e.g., machine learning parameters) stored in a memory unit of image generation apparatus 605 (such as the memory unit 2510 described with reference to FIG. 25). According to some aspects, view generation model 610 comprises an ANN trained to generate an image based on an image and/or text input. In an example, view generation model 610 comprises a guided diffusion model, such as the guided diffusion model described with reference to FIG. 10. According to some aspects, view generation model 610 is trained as described with reference to FIG. 19.

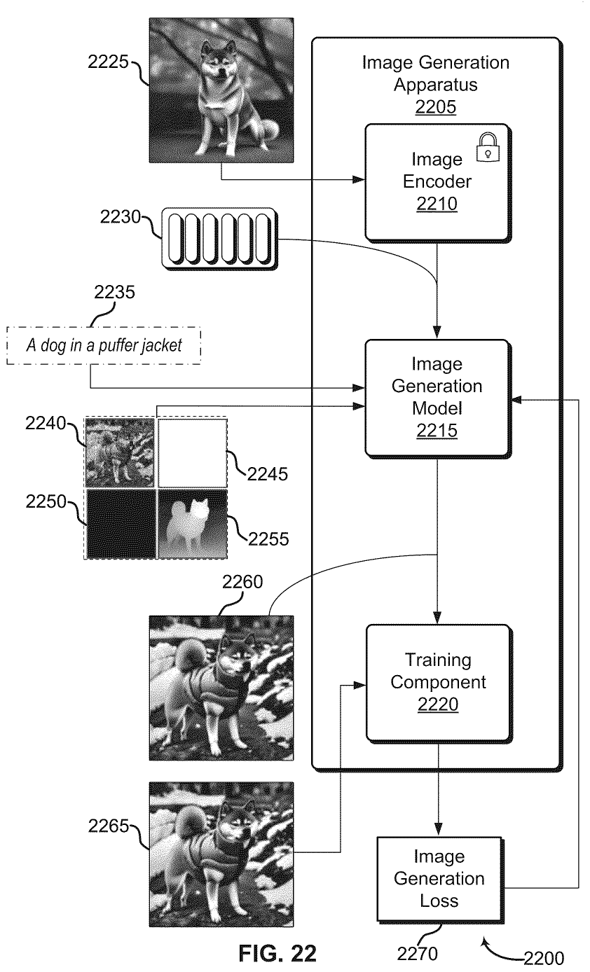

Detail image 615 is an example of, or includes aspects of, the corresponding element described with reference to FIGS. 1, 3-5, and 19-21. Revised image 620 is an example of, or includes aspects of, the corresponding element described with reference to FIG. 22.

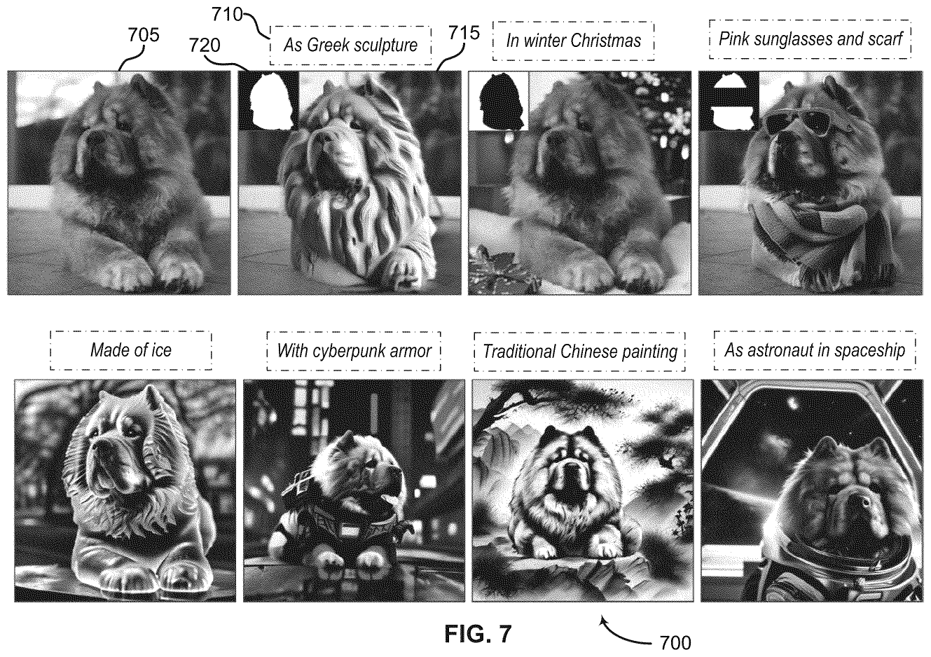

FIG. 7 shows an example 700 of synthetic images generated by a trained image generation model according to aspects of the present disclosure. The example shown includes input image 705, text prompt 710, synthetic image 715, and editing mask 720.

According to some aspects, an image generation model is trained based on a combined image as described with reference to FIGS. 16-17 and 20-22 to generate a synthetic image based on an input image and a text prompt describing a style. FIG. 7 shows examples of synthetic images (including synthetic image 715) generated based on text prompts (including text prompt 710) and input image 705. In particular, synthetic image 715 depicts a dog depicted in input image 705 stylized according to the text prompt 710, “As Greek sculpture”. Synthetic image 715 is shown with an editing mask used to deter the image generation model from altering the background of input image 705.

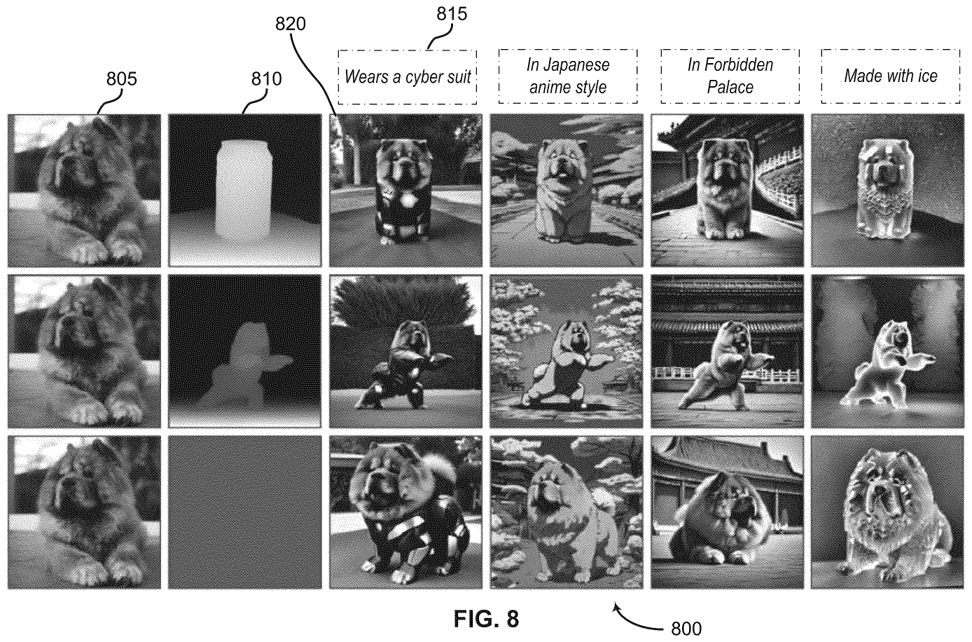

Each synthetic image shown in FIG. 7 depicts the same fine-grained subject details of the dog depicted in input image 705. Some of the synthetic images shown show a change in pose and/or view from input image 705, which may be achieved by providing a depth input to the trained image generation model as described with reference to FIGS. 8 and 23.

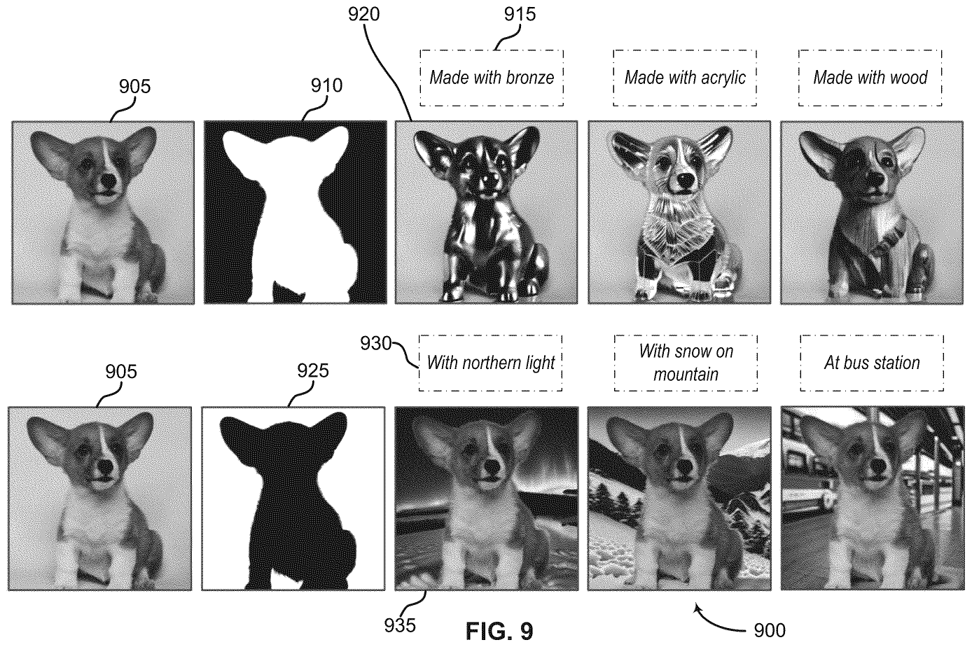

Input image 705 is an example of, or includes aspects of, the corresponding element described with reference to FIGS. 8 and 9. Text prompt 710 is an example of, or includes aspects of, the corresponding element described with reference to FIGS. 4, 5, 8, 9, and 20-22. Synthetic image 715 is an example of, or includes aspects of, the corresponding element described with reference to FIGS. 8 and 9. Editing mask 720 is an example of, or includes aspects of, the corresponding element described with reference to FIGS. 9 and 20-23.

FIG. 8 shows an example 800 of synthetic images having pose or view changes generated by a trained image generation model according to aspects of the present disclosure. The example shown includes input image 805, depth input 810, text prompt 815, and synthetic image 820.

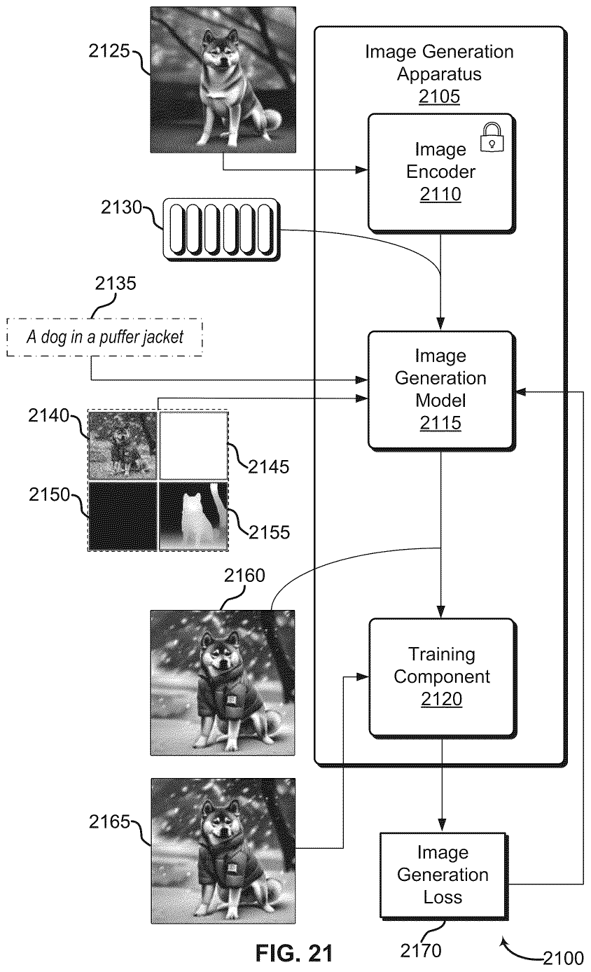

According to some aspects, an image generation model is trained based on a combined image as described with reference to FIGS. 21-22 to generate a synthetic image based on an input image, a text prompt describing a style, and a depth input. FIG. 8 shows examples of synthetic images (including synthetic image 820) generated based on text prompts (including text prompt 815), input image 805, and a depth input (including depth input 810). In particular, synthetic image 820 depicts a dog depicted in input image 805 stylized according to the text prompt 815, “Wears a cyber suit”, with a pose determined by and corresponding to depth input 810. As shown in the bottom row of FIG. 8, an input of a depth input having a single depth may result in a synthetic image depicting a randomized pose and/or view of a subject of an input image.

Input image 805 is an example of, or includes aspects of, the corresponding element described with reference to FIGS. 7 and 9. Text prompt 815 is an example of, or includes aspects of, the corresponding element described with reference to FIGS. 4, 5, 7, 9, and 20-22. Synthetic image 820 is an example of, or includes aspects of, the corresponding element described with reference to FIGS. 7 and 9.

FIG. 9 shows an example 900 of edited images generated by a trained image generation model according to aspects of the present disclosure. The example shown includes input image 905, first editing mask 910, first text prompt 915, first synthetic image 920, second editing mask 925, second text prompt 930, and second synthetic image 935.

According to some aspects, an image generation model is trained based on a combined image as described with reference to FIG. 20 to generate a synthetic image based on an input image, a text prompt describing a style, and an editing mask. FIG. 9 shows an example of synthetic images (including first synthetic image 920 and second synthetic image 935) generated based on input image 905, corresponding text prompts (including first text prompt 915 and second text prompt 930), and corresponding editing masks (including first editing mask 910 and second editing mask 925). First synthetic image 920 depicts the dog of input image 905 according to first text prompt 915, “made with bronze”, while retaining the background of input image 905 due to first editing mask 910, which masks out the background. Second synthetic image 935 depicts the dog of input image 905 and a background according to second text prompt 930, “with northern light”, while retaining the appearance of the dog due to second editing mask 925, which masks out the foreground of input image 905.

Input image 905 is an example of, or includes aspects of, the corresponding element described with reference to FIGS. 7 and 8. First editing mask 910 and second editing mask 925 are examples of, or include aspects of, the corresponding elements described with reference to FIGS. 7 and 20. First text prompt 915 and second text prompt 930 are examples of, or includes aspect of, the corresponding element described with reference to FIGS. 4, 5, 7, 8, and 20-22. First synthetic image 920 and second synthetic image 935 are examples of, or includes aspect of, the corresponding element described with reference to FIGS. 7-8.

FIG. 10 shows an example of a guided diffusion model 1000 according to aspects of the present disclosure. In some examples, guided diffusion model 1000 describes the operation and architecture of the image refinement model 2515 described with reference to FIG. 25, the style image generation model 410 described with reference to FIG. 4, the view generation model 610 described with reference to FIG. 6, and the image generation model described with reference to FIGS. 20-22.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Diffusion models work by iteratively adding noise to the data during a forward process and then learning to recover the data by denoising the data during a reverse process. For example, during training, guided diffusion model 1000 may take an original image 1005 (e.g., a style image as described with reference to FIG. 3) in a pixel space 1010 as input and apply and image encoder 1015 to convert original image 1005 into original image features 1020 in a latent space 1025. Then, a forward diffusion process 1030 gradually adds noise to the original image features 1020 to obtain noisy features 1035 (also in latent space 1025) at various noise levels.

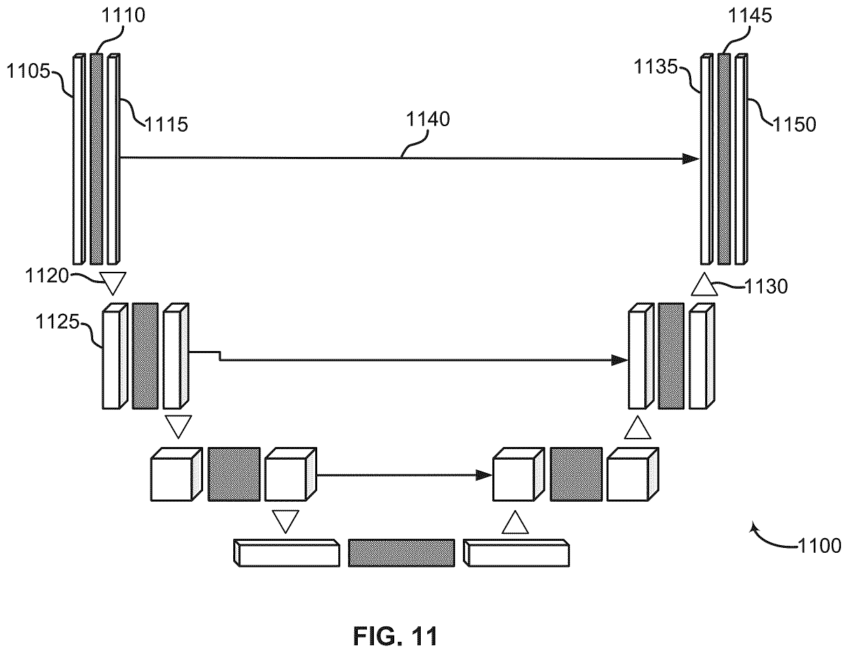

Next, a reverse diffusion process 1040 (e.g., a U-Net ANN, such as the U-Net described with reference to FIG. 11) gradually removes the noise from the noisy features 1035 at the various noise levels to obtain denoised image features 1045 in latent space 1025. In some examples, the denoised image features 1045 are compared to the original image features 1020 at each of the various noise levels, and parameters of the reverse diffusion process 1040 of the diffusion model are updated based on the comparison. Finally, an image decoder 1050 decodes the denoised image features 1045 to obtain an output image 1055 in pixel space 1010. In some cases, an output image 1055 is created at each of the various noise levels. The output image 1055 can be compared to the original image 1005 to train the reverse diffusion process 1040.

In some cases, image encoder 1015 and image decoder 1050 are pre-trained prior to training the reverse diffusion process 1040. In some examples, they are trained jointly, or the image encoder 1015 and image decoder 1050 and fine-tuned jointly with the reverse diffusion process 1040.

The reverse diffusion process 1040 can also be guided based on a text prompt 1060, or another guidance prompt, such as an image, a layout, a segmentation map, etc. The text prompt 1060 can be encoded using an encoder 1065 (e.g., a multimodal encoder) to obtain guidance features 1070 in guidance space 1075. In some embodiments, the combined image embedding described with reference to FIG. 3 is provided as guidance features 1070. The guidance features 1070 can be combined with the noisy features 1035 at one or more layers of the reverse diffusion process 1040 to ensure that the output image 1055 includes content described by the text prompt 1060 or other guidance prompt. For example, guidance features 1070 can be combined with the noisy features 1035 using a cross-attention block within the reverse diffusion process 1040.

Cross-attention, also known as multi-head attention, is an extension of the attention mechanism. In some cases, cross-attention enables reverse diffusion process 1040 to attend to multiple parts of an input sequence simultaneously, capturing interactions and dependencies between different elements. In cross-attention, there are typically two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing reverse diffusion process 1040 to better understand the context and generate more accurate and contextually relevant outputs.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during image generation. Diffusion models may also be characterized by whether the noise is added to the image itself, or to image features generated by an encoder (i.e., latent diffusion). In a pixel diffusion model, noise is added and removed in pixel space. In a latent diffusion model, the noise is added (and removed) in a latent space of image features rather than in pixel space. Thus, a latent diffusion model generates image features using reverse diffusion, and these image features can be decoded to obtain a synthetic image. In some embodiments, guided diffusion model 1000 is implemented as a guided pixel diffusion model.

FIG. 11 shows an example of a U-Net 1100 according to aspects of the present disclosure. In some examples, U-Net 1100 is an example of the component that performs the reverse diffusion process 1040 of guided diffusion model 1000 described with reference to FIG. 10, and includes architectural elements of the image refinement model 2515 described with reference to FIG. 25, the style image generation model 410 described with reference to FIG. 4, the view generation model 610 described with reference to FIG. 6, or the image generation model described with reference to FIGS. 20-22. The U-Net 1100 depicted in FIG. 11 is an example of, or includes aspects of, the architecture used within the reverse diffusion process described with reference to FIG. 10.

In some examples, diffusion models are based on a neural network architecture known as a U-Net. The U-Net 1100 takes input features 1105 having an initial resolution and an initial number of channels and processes the input features 1105 using an initial neural network layer 1110 (e.g., a convolutional network layer) to produce intermediate features 1115. The intermediate features 1115 are then down-sampled using a down-sampling layer 1120 such that down-sampled features 1125 features have a resolution less than the initial resolution and a number of channels greater than the initial number of channels.

This process is repeated multiple times, and then the process is reversed. That is, the down-sampled features 1125 are up-sampled using up-sampling process 1130 to obtain up-sampled features 1135. The up-sampled features 1135 can be combined with intermediate features 1115 having a same resolution and number of channels via a skip connection 1140. These inputs are processed using a final neural network layer 1145 to produce output features 1150. In some cases, the output features 1150 have the same resolution as the initial resolution and the same number of channels as the initial number of channels.

In some cases, U-Net 1100 takes additional input features to produce conditionally generated output. For example, the additional input features could include a vector representation of an input prompt. The additional input features can be combined with the intermediate features 1115 within the neural network at one or more layers. For example, a cross-attention module can be used to combine the additional input features and the intermediate features 1115.

### Image Generation

FIG. 12 shows an example of a method 1200 for generating a combined image based on a combined image embedding according to aspects of the present disclosure. Referring to FIG. 12, an image generation system according to aspects of the present disclosure performs method 1200 to generate a combined image based on a combined image embedding, which is generated based on a detail image and a style image.

In some embodiments, the detail image and the style image are encoded to obtain a detail image embedding and a style image embedding, respectively. The detail image includes a first patch depicting an image element and the style image includes a second patch depicting a corresponding image element and a third patch depicting a style element. In some embodiments, the combined image embedding includes a detail embedding patch generated based on a similarity between the image element and the corresponding image element, and a style embedding patch representing the style element. The combined image generated based on the combined image embedding therefore accurately depicts the image element from the detail image and the style element from the style image.

Furthermore, in some embodiments, the detail image, the text prompt, and the combined image can be used as training data to train an image generation model to accurately and efficiently generate stylized images based on a text prompt and an input image.

At operation 1205, the system obtains a detail image and a style image, where the detail image depicts includes a first region depicting an image element, and where the style image includes a second region depicting a corresponding image element and a third region depicting a style element. In some cases, the operations of this step refer to, or may be performed by, an image generation apparatus as described with reference to FIGS. 1, 3, 4, 6, 18-22, and 24-25.

In an example, a user provides one or more of the detail image and the style image to the image generation apparatus. In an example, the image generation apparatus retrieves one or more of the detail image and the style image from a database (such as the database 125 described with reference to FIG. 1). In some embodiments, the image generation apparatus generates the style image based on a text prompt describing the style element as described with reference to FIG. 4. In some embodiments, the image generation apparatus generates the style image based on the detail image as described with reference to FIG. 4.

At operation 1210, the system generates a combined image embedding including a detail embedding patch and a style embedding patch based on the detail image and the style image, where the detail embedding patch corresponds to the second region of the style image and represents the image element from the first region of the detail image based on a similarity between the image element and the corresponding image element, and where the style embedding patch corresponds to the third region of the style image and represents the style element. In some cases, the operations of this step refer to, or may be performed by, an embedding combination component as described with reference to FIG. 3.

According to some aspects, the detail image includes a first region depicting the image element, the style image includes a second region depicting a corresponding image element and a third region depicting a style element, the detail embedding patch corresponds to the second region of the style image and represents the image element from the first region of the detail image based on a similarity between the image element and the corresponding image element, and the style embedding patch corresponds to the third region of the style image and represents the style element.

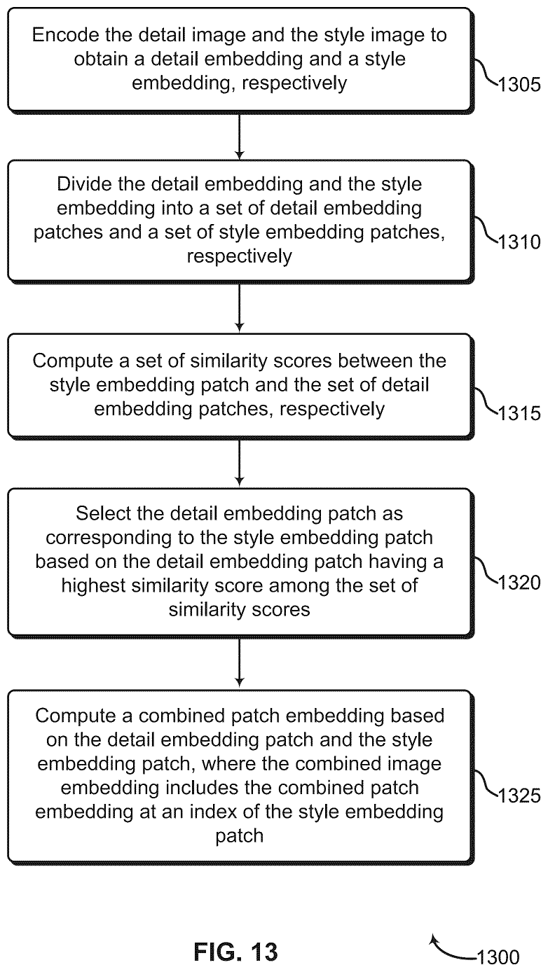

In an example, the embedding combination component generates the combined image embedding as described with reference to FIG. 3. In some embodiments, the image generation system generates the combined image embedding as described with reference to FIG. 13.

At operation 1215, the system generates, using an image refinement model, a combined image based on the combined image embedding, where the combined image depicts the image element from the detail image and the style element from the style image. In some cases, the operations of this step refer to, or may be performed by, an image refinement model as described with reference to FIGS. 1, 3, 18, and 25.

In some embodiments, the combined image depicts the image element from the first region of the detail image and the style element from the third region of the style image. In an example, the image refinement model generates the combined image as described with reference to FIG. 3. According to some aspects, the image refinement model is trained to generate a synthetic image based on an image embedding as described with reference to FIGS. 16-18.

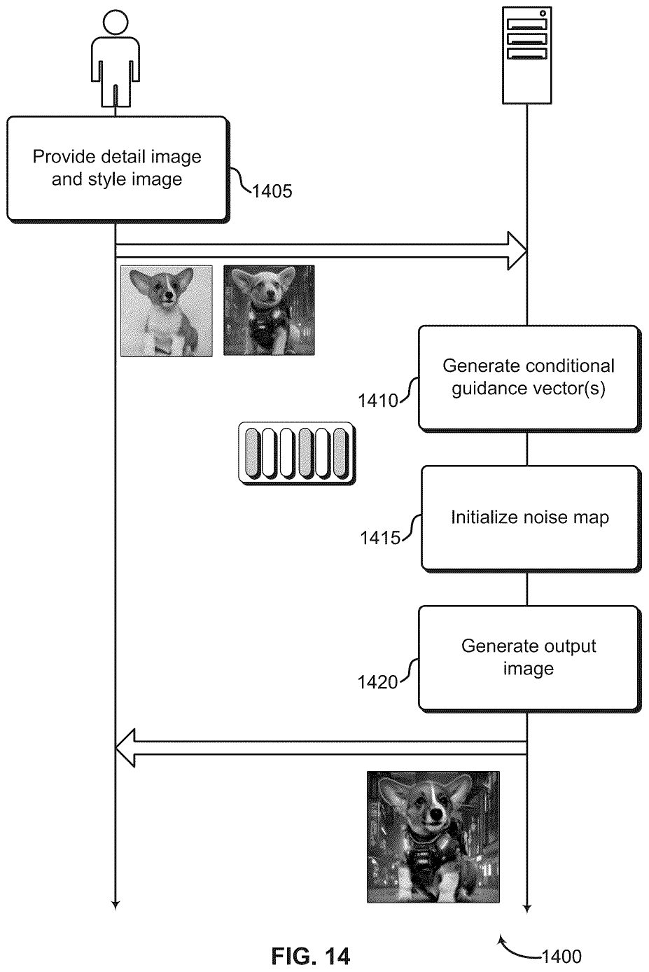

According to some aspects, the image generation system uses the combined image as training data for training an image generation model to generate a synthetic image, for example as described with reference to FIGS. 16-17 and 20-23. According to some aspects, the trained image generation model generates the synthetic image as described with reference to FIG. 14.

According to some aspects, a view generator model, such as the view generator model described with reference to FIG. 6, generates a revised image based on the detail image, where the revised image depicts the image element from a different view than the detail image. In an example, the view generator model generates the revised image as described with reference to FIG. 6. According to some aspects, the view generator model is trained as described with reference to FIGS. 16-17 and 19. According to some aspects, the image generation model is trained to generate the synthetic image using the revised image as training data, for example as described with reference to FIG. 22.

FIG. 13 shows an example of a method 1300 for computing a combined image embedding including a combined patch embedding according to aspects of the present disclosure. Referring to FIG. 13, an image generation system (such as the image generation system 100 described with reference to FIG. 1) generates a combined image embedding based on a detail image and a style image.

At operation 1305, the system encodes the detail image and the style image to obtain a detail embedding and a style embedding, respectively. In some cases, the operations of this step refer to, or may be performed by, an image encoder as described with reference to FIGS. 3, 18-22, and 25. In an example, the image encoder obtains the detail embedding and the style embedding as described with reference to FIG. 3.

At operation 1310, the system divides the detail embedding and the style embedding into a set of detail embedding patches and a set of style embedding patches, respectively. In some cases, the operations of this step refer to, or may be performed by, an image encoder as described with reference to FIGS. 3, 18-22, and 25. In an example, the image encoder obtains the set of detail embedding patches and the set of style embedding patches as described with reference to FIG. 3.

At operation 1315, the system computes a set of similarity scores between the style embedding patch and the set of detail embedding patches, respectively. In some cases, the operations of this step refer to, or may be performed by, an embedding combination component as described with reference to FIG. 3. In an example, the embedding combination component computes the set of similarity scores as described with reference to FIG. 3.

At operation 1320, the system selects the detail embedding patch as corresponding to the style embedding patch based on the detail embedding patch having a highest similarity score among the set of similarity scores. In some cases, the operations of this step refer to, or may be performed by, an embedding combination component as described with reference to FIG. 3. In an example, the embedding combination component selects the detail embedding patch as described with reference to FIG. 3.

At operation 1325, the system computes a combined patch embedding based on the detail embedding patch and the style embedding patch, where the combined image embedding includes the combined patch embedding at an index of the style embedding patch. In some cases, the operations of this step refer to, or may be performed by, an embedding combination component as described with reference to FIG. 3. In an example, the embedding combination computes the combined patch embedding as described with reference to FIG. 3

FIG. 14 shows an example of a method for conditional image generation according to aspects of the present disclosure. In some examples, method 1400 describes an operation of an image refinement model trained 2515 as described with reference to FIG. 25 such as an application of the guided diffusion model 1000 described with reference to FIG. 10. In some examples, these operations are performed by a system including a processor executing a set of codes to control functional elements of an apparatus such as the guided diffusion model described in FIG. 10.

Additionally or alternatively, steps of the method 1400 may be performed using special-purpose hardware. Generally, these operations are performed according to the methods and processes described in accordance with aspects of the present disclosure. In some cases, the operations described herein are composed of various substeps or are performed in conjunction with other operations.

At operation 1405, a user provides a detail image and a style image depicting elements to be included in a generated image. In the example of FIG. 14, a user provides a detail image depicting a dog and a style image depicting a corresponding dog and a futuristic cityscape and harness.

At operation 1410, generates conditional guidance vector(s). In an example, a combined image embedding is generated based on the detail image and the style image as described with reference to FIGS. 3 and 12, where the combined image embedding is a conditional guidance vector.

At operation 1415, a noise map is initialized that includes random noise. In an example, the noise map is generated based on the style image. The noise map may be in a pixel space or a latent space.

At operation 1420, the system generates an output image. In an example, the image refinement model generates the combined image by denoising the noise map using a reverse diffusion process guided by the combined image embedding as described with reference to FIGS. 10 and 15.

FIG. 15 shows an example of a diffusion process 1500 according to aspects of the present disclosure. In some examples, diffusion process 1500 describes an operation of the image refinement model 2515 described with reference to FIG. 25, the style image generation model 410 described with reference to FIG. 4, the view generation model 610 described with reference to FIG. 6, or the image generation model described with reference to FIGS. 20-22, such as the reverse diffusion process 1040 of guided diffusion model 1000 described with reference to FIG. 10.

As described above with reference to FIG. 10, using a diffusion model can involve both a forward diffusion process 1505 for adding noise to an image (or features in a latent space) and a reverse diffusion process 1510 for denoising the images (or features) to obtain a denoised image. The forward diffusion process 1505 can be represented as q(xₜ|xₜ₋₁), and the reverse diffusion process 1510 can be represented as p(xₜ₋₁|xₜ). In some cases, the forward diffusion process 1505 is used during training to generate images with successively greater noise, and a neural network is trained to perform the reverse diffusion process 1510 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T} |x₀) as the latent variables are passed through a neural network such as a U-Net, where x₁, . . . , x_{T} have the same dimensionality as x₀.

The neural network may be trained to perform the reverse process. During the reverse diffusion process 1510, the model begins with noisy data x_{T}, such as a noisy image 1515, and denoises the data to obtain the p(xₜ₋₁|xₜ). At each step t−1, the reverse diffusion process 1510 takes xₜ, such as first intermediate image 1520, and t as input. Here, t represents a step in the sequence of transitions associated with different noise levels, The reverse diffusion process 1510 outputs xₜ₋₁, such as second intermediate image 1525 iteratively until x_{T} reverts back to x₀, the original image 1530. The reverse process can be represented as:

$${p}_{θ} ( {x}_{t - 1} \vert {x}_{t} ) := N ( {x}_{t - 1} ; {μ}_{θ} ( {x}_{t} , t ) {Σ}_{θ} ( {x}_{t} , t ) ) . \qquad ( 3 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 4 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and x represents the generated image with high image quality.

Accordingly, a method for image generation is described. One or more aspects of the method include obtaining a detail image and a style image, wherein the detail image depicts includes a first region depicting an image element, and wherein the style image includes a second region depicting a corresponding image element and a third region depicting a style element; generating a combined image embedding including a detail embedding patch and a style embedding patch based on the detail image and the style image, wherein the detail embedding patch corresponds to the second region of the style image and represents the image element from the first region of the detail image based on a similarity between the image element and the corresponding image element, and wherein the style embedding patch corresponds to the third region of the style image and represents the style element; and generating, using an image refinement model, a combined image based on the combined image embedding, wherein the combined image depicts the image element from the first region of the detail image and the style element from the third region of the style image.

Some examples of the method further include obtaining a text prompt describing the style element. Some examples further include generating the style image based on the text prompt. In some aspects, the style image is generated based on the detail image. In some aspects, the detail image includes a first region depicting the image element, the style image includes a second region depicting a corresponding image element and a third region depicting a style element, the detail embedding patch corresponds to the second region of the style image and represents the image element from the first region of the detail image based on a similarity between the image element and the corresponding image element, and the style embedding patch corresponds to the third region of the style image and represents the style element.

Some examples of the method further include encoding the detail image and the style image to obtain a detail embedding and a style embedding, respectively. Some examples further include dividing the detail embedding and the style embedding into a plurality of detail embedding patches and a plurality of style embedding patches, respectively, wherein the combined image embedding is based on the plurality of detail embedding patches and the plurality of style embedding patches.

Some examples of the method further include computing a plurality of similarity scores between the style embedding patch and the plurality of detail embedding patches, respectively. Some examples further include selecting the detail embedding patch as corresponding to the style embedding patch based on the detail embedding patch having a highest similarity score among the plurality of similarity scores. Some examples further include computing a combined patch embedding based on the detail embedding patch and the style embedding patch, wherein the combined image embedding includes the combined patch embedding at an index of the style embedding patch.

Some examples of the method further include using the combined image as training data for training an image generation model to generate a synthetic image. In some aspects, the image generation model is trained by generating a revised image as training data based on the detail image. In some aspects, the image refinement model is trained to generate a synthetic image based on an image embedding.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

### Training

FIG. 16 shows an example of a flow diagram depicting an algorithm as a step-by-step procedure 1600 for training a machine learning model according to aspects of the present disclosure. In some embodiments, the procedure 1600 describes an operation of the training component 1820 described for configuring the image refinement model 1815 as described with reference to FIG. 18. In some embodiments, the procedure 1600 describes an operation of the training component 1920 described for configuring the view generation model 1915 as described with reference to FIG. 19. In some embodiments, the procedure 1600 describes an operation of the training component 2020 described for configuring the image generation model 2015 as described with reference to FIG. 20. In some embodiments, the procedure 1600 describes an operation of the training component 2120 described for configuring the image generation model 2115 as described with reference to FIG. 21. In some embodiments, the procedure 1600 describes an operation of the training component 2220 described for configuring the image generation model 2215 as described with reference to FIG. 23. In some embodiments, the procedure 1600 describes an operation of the training component 2525 described for configuring the image refinement model 2515 as described with reference to FIG. 25. The procedure 1600 provides one or more examples of generating training data, use of the training data to train a machine learning model, and use of the trained machine learning model to perform a task.

To begin in this example, a machine learning system collects training data (block 1602) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1604) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1606). Initialization of the machine learning model includes selecting a model architecture (block 1608) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1610). The loss function is utilized to measure a difference between an output of the machine learning model (i.e., predictions) and target values (e.g., as expressed by the training data) to be used to train the machine learning model. Additionally, an optimization algorithm is selected (1612) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1614) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1618) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1620), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1620), the procedure 1600 continues training of the machine learning model using the training data (block 1618) in this example.

If the stopping criterion is met (“yes” from decision block 1620), the trained machine learning model is then utilized to generate an output based on subsequent data (block 1622). The trained machine learning model, for instance, is trained to perform a task as described above and therefore once trained is configured to perform that task based on subsequent data received as an input and processed by the machine learning model.

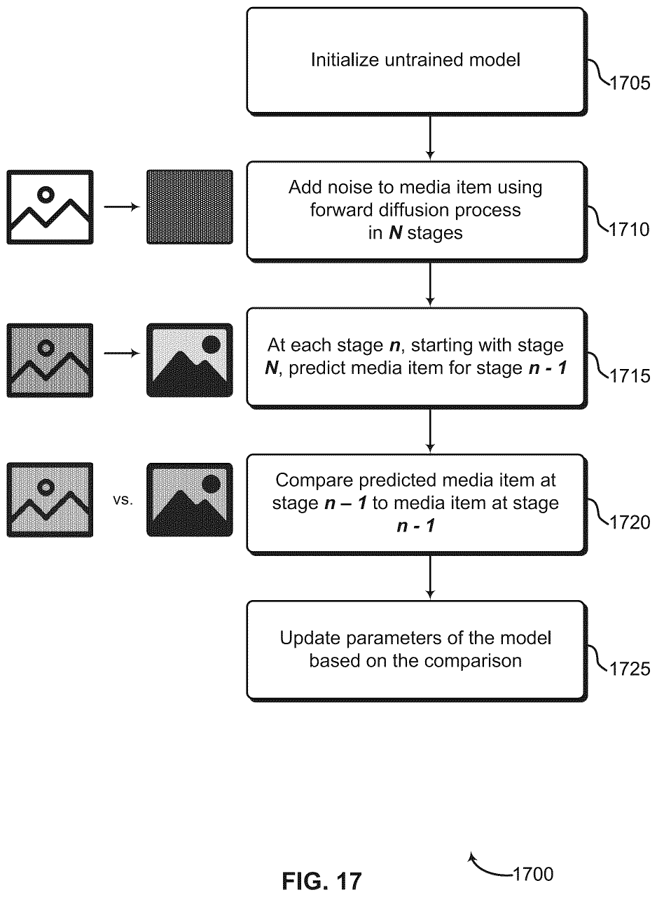

FIG. 17 shows an example of a method 1700 for training a diffusion model according to aspects of the present disclosure. In some embodiments, the method 1700 describes an operation of the training component 1820 described for configuring the image refinement model 1815 as described with reference to FIG. 18. In some embodiments, the method 1700 describes an operation of the training component 1920 described for configuring the view generation model 1915 as described with reference to FIG. 19. In some embodiments, the method 1700 describes an operation of the training component 2020 described for configuring the image generation model 2015 as described with reference to FIG. 20. In some embodiments, the method 1700 describes an operation of the training component 2120 described for configuring the image generation model 2315 as described with reference to FIG. 21. In some embodiments, the method 1700 describes an operation of the training component 2220 described for configuring the image generation model 2215 as described with reference to FIG. 22. In some embodiments, the method 1700 describes an operation of the training component 2525 described for configuring the image refinement model 2515 as described with reference to FIG. 25. The method 1700 represents an example for training a reverse diffusion process as described above with reference to FIG. 15. In some examples, these operations are performed by a system including a processor executing a set of codes to control functional elements of an apparatus, such as the guided diffusion model described in FIG. 10.

Additionally or alternatively, certain processes of method 1700 may be performed using special-purpose hardware. Generally, these operations are performed according to the methods and processes described in accordance with aspects of the present disclosure. In some cases, the operations described herein are composed of various substeps or are performed in conjunction with other operations.

At operation 1705, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1710, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1715, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1720, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1725, the system updates parameters of the model based on the comparison. For example, parameters of a U-Net may be updated using gradient descent. Time-dependent parameters of the Gaussian transitions can also be learned.

FIG. 18 shows an example of an image generation system 1800 for training an image refinement model according to aspects of the present disclosure. The example shown includes image generation system 1800, image 1825, image embedding 1830, predicted synthetic image 1835, and image refinement loss 1840. In one aspect, image generation system 1800 includes image generation apparatus 1805. In one aspect, image generation apparatus 1805 includes image encoder 1810, image refinement model 1815, and training component 1820.

Referring to FIG. 18, according to some aspects, image refinement model 1815 is trained to generate a synthetic image based on an image. For example, image encoder 1810 generates an image embedding (e.g., image embedding 1830) based on an image (e.g., image 1825), image refinement model 1815 generates a predicted synthetic image (e.g., predicted synthetic image 1835) based on the image embedding, training component 1820 determines an image refinement loss 1840 based on the predicted synthetic image and the image, and training component 1820 updates the parameters of image refinement model 1815 according to image refinement loss 1840.

In some embodiments, training component 1820 computes image refinement loss 1840 as a diffusion loss according to Eq. 5:

$${ℒ}_{θ} = [ {‖ ϵ - {R}_{θ} ( f ( x ) , {x}_{t} , t ) ‖}^{2} ] \qquad ( 5 )$$

In Eq. 5, R_{θ} denotes image refinement model 1815, f denotes image encoder 1810, ∈˜ [symbol] (0, I) denotes randomly sampled noise, xₜ denotes the image at time t with added noise, and x denotes the image without noise. In some embodiments, the image embedding f(x) is injected into a U-Net of image refinement model 1815 through cross-attention layers. Accordingly, image refinement model 1815 learns to reconstruct an input image based on an image embedding of the input image provided by image encoder 1810. In FIG. 18, the lock icon indicates that in some embodiments, image encoder 1810 is frozen (not trained) while image refinement model 1815 is trained.

Image generation system 1800 is an example of, or includes aspects of, the corresponding element described with reference to FIGS. 1, 3, 4, 6, and 19-22. Image generation apparatus 1805 is an example of, or includes aspects of, the corresponding element described with reference to FIGS. 1, 3, 4, 6, 19-22, and 24-25. Image encoder 1810 is an example of, or includes aspects of, the corresponding element described with reference to FIGS. 3, and 19-22. Image refinement model 1815 is an example of, or includes aspects of, the corresponding element described with reference to FIGS. 1, 3, and 25. Training component 1820 is an example of, or includes aspects of, the corresponding element described with reference to FIGS. 19-22 and 25.

FIG. 19 shows an example of an image generation system 1900 for training a view generation model 1915 according to aspects of the present disclosure. The example shown includes image generation system 1900, detail image 1925, detail image embedding 1930, predicted target image 1935, target image 1940, and view generation loss 1945. In one aspect, image generation system 1900 includes image generation apparatus 1905. In one aspect, image generation apparatus 1905 includes image encoder 1910, view generation model 1915, and training component 1920.

Referring to FIG. 19, according to some aspects, image encoder 1910 generates a detail image embedding (e.g., detail image embedding 1930) based on a detail image (e.g., detail image 1925). View generation model 1915 generates a predicted target image (e.g., predicted target image 1935) based on the detail image embedding. Training component 1920 computes view generation loss 1945 based on the predicted target image and a target image (e.g., target image 1940). Training component 1920 updates the parameters of view generation model 1915 according to view generation loss 1945.

In some embodiments, training component 1920 computes view generation loss 1945 as a diffusion loss according to Eq. 6:

$${ℒ}_{ϕ} = [ {‖ ϵ - {G}_{ϕ} ( f ( x ) , {\tilde{x}}_{t} , t ) ‖}^{2} ] \qquad ( 6 )$$

In Eq. 6, G_{φ} denotes view generation model 1915, f denotes image encoder 1910, ∈˜ [symbol] (0, I) denotes randomly sampled noise, x denotes detail image 1925, \tilde{x} denotes the target image, and \tilde{x}ₜ denotes the target image at time t with added noise. In some embodiments, the image embedding f(x) is injected into a U-Net of view generation model 1915 through cross-attention layers. In some embodiments, target image \tilde{x} is an image depicting a same subject as detail image x with a different pose and/or from a different view. Accordingly, view generation model 1915 learns to generate a revised image depicting an image element from a different view and/or with a different pose than the detail image based on a detail image embedding of the detail image provided by image encoder 1910. In FIG. 19, the lock icon indicates that in some embodiments, image encoder 1910 is frozen (not trained) while view generation model 1915 is trained.

Image generation system 1900 is an example of, or includes aspects of, the corresponding element described with reference to FIGS. 1, 3, 4, 6, 18, and 20-22. Image generation apparatus 1905 is an example of, or includes aspects of, the corresponding element described with reference to FIGS. 1, 3, 4, 6, 18, 20-22, and 24-25. Image encoder 1910 is an example of, or includes aspects of, the corresponding element described with reference to FIGS. 3, 18, and 20-22.

View generation model 1915 is an example of, or includes aspects of, the corresponding element described with reference to FIG. 6. Training component 1920 is an example of, or includes aspects of, the corresponding element described with reference to FIGS. 18, 20-22, and 25. Detail image 1925 is an example of, or includes aspects of, the corresponding element described with reference to FIGS. 1, 3-6, and 20-21. Detail image embedding 1930 is an example of, or includes aspects of, the corresponding element described with reference to FIGS. 3 and 20-21.

FIG. 20 shows an example of an image generation system 2000 for training an image generation model to perform image editing according to aspects of the present disclosure. The example shown includes image generation system 2000, detail image 2025, detail image embedding 2030, text prompt 2035, noisy combined image 2040, editing mask 2045, masked image 2050, combined image depth map 2055, predicted combined image 2060, combined image 2065, and image generation loss 2070. In one aspect, image generation system 2000 includes image generation apparatus 2005. In one aspect, image generation apparatus 2005 includes image encoder 2010, image generation model 2015, and training component 2020.

Referring to FIG. 20, according to some aspects, a detail image (e.g., detail image 2025) and a combined image (e.g., combined image 2065) generated based on the detail image as described with reference to FIG. 3 are used as training data to train image generation model 2015 to perform image editing by generating a synthetic image including a foreground or a background of an input image stylized according to a style element described by a text prompt.

In an example, image encoder 2010 generates a detail image embedding (e.g., detail image embedding 2030) based on the detail image. Image generation model 2015 generates a predicted combined image (e.g., predicted combined image 2060) by denoising a noisy combined image (e.g., noisy combined image 2040, or combined image 2065 with noise added by a forward diffusion process) using the detail image embedding as guidance features. Furthermore, image generation model 2015 uses a text prompt describing a style element depicted in the combined image (e.g., text prompt 2035), an editing mask with a white foreground (e.g., editing mask 2045), a masked image with a black foreground and a background depicted in the combined image (e.g., masked image 2050), and a depth map of the combined image (e.g., combined image depth map 2055) as guidance inputs (e.g., with corresponding embeddings as guidance features).

In some embodiments, the editing mask, the masked image, and the noisy image are concatenated along a channel dimension before being provided to image generation model 2015. In some embodiments, the depth map is injected into image generation model 2015 via a ControlNet. In some embodiments, the detail image embedding is introduced into image generation model 2015 via cross-attention layers. In some embodiments, corresponding cross-attention layer outputs of image encoder 2010 and a text encoder that generates a text embedding of the text prompt are added in an element-wise layer before being fed into a next layer of a U-Net of image generation model 2015.

In some embodiments, the depth map is replaced with a constant image (e.g., a monochrome gray image), thereby training the image generation model to generate a synthetic image having a new view that is different from a view of an input image, as described with reference to FIG. 8. In some embodiments, during inference, providing a depth map as input to the trained image generation model causes the trained image generation model to generate a synthetic image depicting a subject with a pose corresponding to the depth map. In some embodiments, providing a depth map of an input image as a depth input will cause the structural information of the input image to be preserved in the synthetic image.

In the example, training component 2020 computes image generation loss 2070 (e.g., a diffusion loss) based on the predicted combined image and the combined image. In some embodiments, the combined image is generated based on the detail image as described with reference to FIG. 3 and a style image generated based on the text prompt as described with reference to FIG. 4. In some embodiments, the combined image includes a same background as the detail image. Training component updates the parameters of image generation model 2015 according to image generation loss 2070.

In FIG. 20, the lock icon indicates that in some embodiments, image encoder 2010 is frozen (not trained) while image generation model 2015 is trained.

Image generation system 2000 is an example of, or includes aspects of, the corresponding element described with reference to FIGS. 1, 3, 4, 6, 18-19, and 21-22. Image generation apparatus 2005 is an example of, or includes aspects of, the corresponding element described with reference to FIGS. 1, 3, 4, 6, 18-19, 21-22, and 24-25. Image encoder 2010 is an example of, or includes aspects of, the corresponding element described with reference to FIGS. 3, 18-19, and 21-22.

Image generation model 2015 is an example of, or includes aspects of, the corresponding element described with reference to FIGS. 21-22. According to some aspects, image generation model 2015 comprises image generation parameters (e.g., machine learning parameters) stored in a memory unit of image generation apparatus 2005 (such as the memory unit 2510 described with reference to FIG. 25). According to some aspects, image generation model 2015 comprises an ANN trained to generate an image based on an image and/or text input. In an example, image generation model 2015 comprises a guided diffusion model, such as the guided diffusion model described with reference to FIG. 10.

Training component 2020 is an example of, or includes aspects of, the corresponding element described with reference to FIGS. 18-19, 21-22, and 25. Detail image 2025 is an example of, or includes aspects of, the corresponding element described with reference to FIGS. 1, 3-6, 19, and 21. Detail image embedding 2030 is an example of, or includes aspects of, the corresponding element described with reference to FIGS. 3, 19, and 21.

Text prompt 2035 is an example of, or includes aspects of, the corresponding element described with reference to FIGS. 4, 5, 7-9, and 21-22. Noisy combined image 2040, masked image 2050, combined image depth map 2055, predicted combined image 2060, and image generation loss 2070 are examples of, or include aspects of, the corresponding elements described with reference to FIGS. 21-22. Editing mask 2045 is an example of, or includes aspects of, the corresponding element described with reference to FIGS. 7, 9, and 21-22. Combined image 2065 is an example of, or includes aspects of, the corresponding element described with reference to FIGS. 1, 3, 5, and 21-22.

FIG. 21 shows an example of an image generation system 2100 for training an image generation model to perform image generation according to aspects of the present disclosure. The example shown includes image generation system 2100, detail image 2125, detail image embedding 2130, text prompt 2135, noisy combined image 2140, editing mask 2145, masked image 2150, combined image depth map 2155, predicted combined image 2160, combined image 2165, and image generation loss 2170. In one aspect, image generation system 2100 includes image generation apparatus 2105. In one aspect, image generation apparatus 2105 includes image encoder 2110, image generation model 2115, and training component 2120.

Referring to FIG. 21, according to some aspects, a detail image (e.g., detail image 2125) and a combined image (e.g., combined image 2165) generated based on the detail image as described with reference to FIG. 3 are used as training data to train image generation model 2115 to perform image generation by stylizing an input image according to a style element described by a text prompt. FIG. 21 illustrates a similar system as FIG. 20, and repeated descriptions thereof are omitted for the sake of brevity. Comparing FIG. 21 to FIG. 20, editing mask 2145 is all white and masked image 2150 is all black, and the background of combined image 2165 is different from the background of detail image 2125.

Image generation system 2100 is an example of, or includes aspects of, the corresponding element described with reference to FIGS. 1, 3, 4, 6, 18-20, and 22. Image generation apparatus 2105 is an example of, or includes aspects of, the corresponding element described with reference to FIGS. 1, 3, 4, 6, 18-20, 22, 24, and 25. Image encoder 2110 is an example of, or includes aspects of, the corresponding element described with reference to FIGS. 3, 18-20, and 22. Image generation model 2115 is an example of, or includes aspects of, the corresponding element described with reference to FIGS. 20 and 22. Training component 2120 is an example of, or includes aspects of, the corresponding element described with reference to FIGS. 18-20, 22, and 25.

Detail image 2125 is an example of, or includes aspects of, the corresponding element described with reference to FIGS. 1, 3-6, 19, and 20. Detail image embedding 2130 is an example of, or includes aspects of, the corresponding element described with reference to FIGS. 3, 19, and 20. Text prompt 2135 is an example of, or includes aspects of, the corresponding element described with reference to FIGS. 4, 5, 7-9, 20, and 22. Noisy combined image 2140, masked image 2150, combined image depth map 2155, predicted combined image 2160, and image generation loss 2170 are examples of, or include aspects of, the corresponding elements described with reference to FIGS. 20 and 22. Editing mask 2145 is an example of, or includes aspects of, the corresponding element described with reference to FIGS. 7, 9, 20, and 22. Combined image 2165 is an example of, or includes aspects of, the corresponding element described with reference to FIGS. 1, 3, 5, 20, and 22.

FIG. 22 shows an example of an image generation system 2200 for training an image generation model 2215 to perform image generation with pose or view change according to aspects of the present disclosure. The example shown includes image generation system 2200, revised image 2225, revised image embedding 2230, text prompt 2235, noisy combined image 2240, editing mask 2245, masked image 2250, combined image depth map 2255, predicted combined image 2260, combined image 2265, and image generation loss 2270. In one aspect, image generation system 2200 includes image generation apparatus 2205. In one aspect, image generation apparatus 2205 includes image encoder 2210, image generation model 2215, and training component 2220.

Referring to FIG. 22, according to some aspects, a revised image (e.g., revised image 2225) generated based on a detail image as described with reference to FIG. 6 and a combined image (e.g., combined image 2265) generated based on the detail image as described with reference to FIG. 3 are used as training data to train image generation model 2215 to perform image generation by stylizing an input image according to a style element described by a text prompt and a view and/or pose change provided by a depth input. FIG. 22 illustrates a similar system as FIG. 21, and repeated descriptions thereof are omitted for the sake of brevity.

Comparing FIG. 22 and FIG. 21, image generation model 2215 generates a predicted combined image (e.g., predicted combined image 2260) using a revised image embedding (e.g., revised image embedding 2230) generated by image encoder 2210 based on the revised image as guidance rather than a detail image embedding. Both the revised image and the combined image are generated based on a same detail image (not shown).

Image generation system 2200 is an example of, or includes aspects of, the corresponding element described with reference to FIGS. 1, 3, 4, 6, and 18-21. Image generation apparatus 2205 is an example of, or includes aspects of, the corresponding element described with reference to FIGS. 1, 3, 4, 6, 18-21, 24, and 25. Image encoder 2210 is an example of, or includes aspects of, the corresponding element described with reference to FIGS. 3, and 18-21. Image generation model 2215 is an example of, or includes aspects of, the corresponding element described with reference to FIGS. 20 and 21. Training component 2220 is an example of, or includes aspects of, the corresponding element described with reference to FIGS. 18-21, and 25.

Revised image 2225 is an example of, or includes aspects of, the corresponding element described with reference to FIG. 6. Text prompt 2235 is an example of, or includes aspects of, the corresponding element described with reference to FIGS. 4, 5, 7-9, 20, and 21. Noisy combined image 2240, masked image 2250, combined image depth map 2255, predicted combined image 2260, and image generation loss 2270 are examples of, or include aspects of, the corresponding elements described with reference to FIGS. 20-21. Editing mask 2245 is an example of, or includes aspects of, the corresponding element described with reference to FIGS. 7, 9, 20, and 21. Combined image 2265 is an example of, or includes aspects of, the corresponding element described with reference to FIGS. 1, 3, 5, 20, and 21.

FIG. 23 shows an example of a taxonomy 2300 of an image generation model training set according to aspects of the present disclosure. Referring to FIG. 23, according to some aspects, image pairs for the training set are obtained using the image refinement model described with reference to FIG. 3 and/or the view generation model described with reference to FIG. 6.

For example, in some embodiments, the image generation system obtains a set of detail images including various subjects from different classes and a set of text prompts. The image generation system generates a set of style images based on the set of detail images and the set of text prompts and generates a set of combined images based on the set of detail images and the set of style images. Some of the set of style images are generated based on an editing mask such that some elements of the detail images are preserved in the style images and therefore the combined images that are generated based on the style images. The editing masks may be obtained using a machine learning model configured to detect image objects and generate masks based on the detected objects. An image pair of the training set may include a detail image and a combined image generated based on the detail image. Another image pair for the training set may include a revised image and a combined image generated based on a common detail image.

In some embodiments, the image generation system removes an image pair from the training set if one image of the pair is too dissimilar from the other image of the image pair. For example, the image generation system generates an embedding of each of the images of the image pair and removes the image pair if a similarity between the image embeddings is less than a threshold similarity. The image generation system thereby filters out image pairs depicting dissimilar subjects.

In some embodiments, the image generation system removes an image pair from the training set if the combined image of the training pair is too dissimilar from a text prompt used to generate the style image corresponding to the combined image. For example, the image generation system generates an embedding of the combined image in a multimodal embedding space and generates an embedding of the text prompt in the multimodal embedding space and removes the image pair if a similarity between the image embedding and the text embedding is less than a threshold similarity. The image generation system thereby filters out low-quality samples that are not text-aligned.

According to some aspects, the image generation system obtains a large-scale dataset comprising many (e.g., millions) of image pairs including image editing pairs with associated image editing masks. Taxonomy 2300 shows a categorization of image editing pairs and image generation pairs according to types of changes that the image pairs train the image generation model to perform.

Accordingly, the image generation model trained using the training set is a unified model capable of both subject-driven, zero-shot image editing and generation, with or without pose and/or view change, without test-time fine-tuning using a single network, and fully controllable by a user.

### Image Generation Apparatus

FIG. 24 shows an example of a computing device according to aspects of the present disclosure. Computing device 2400 is an example of, or includes aspects of, the image generation apparatus described with reference to FIGS. 1, 3, 4, 6, 18-22, and 25. In one aspect, computing device 2400 includes processor(s) 2405, memory subsystem 2410, communication interface 2415, I/O interface 2420, user interface component(s) 2425, and channel 2430.

In some embodiments, computing device 2400 is an example of, or includes aspects of, the image generation model of FIG. 10. In some embodiments, computing device 2400 includes one or more processors 2405 that can execute instructions stored in memory subsystem 2410 to perform image generation.

According to some aspects, computing device 2400 includes one or more processors 2405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2415 operates at a boundary between communicating entities (such as computing device 2400, one or more user devices, a cloud, and one or more databases) and channel 2430 and can record and process communications. In some cases, communication interface 2415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2420 is controlled by an I/O controller to manage input and output signals for computing device 2400. In some cases, I/O interface 2420 manages peripherals not integrated into computing device 2400. In some cases, I/O interface 2420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating systems. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2420 or via hardware components controlled by the I/O controller.

According to some aspects, user interface component(s) 2425 enable a user to interact with computing device 2400. In some cases, user interface component(s) 2425 include an audio device, such as an external speaker system, an external display device such as a display screen, an input device (e.g., a remote-control device interfaced with a user interface directly or through the I/O controller), or a combination thereof. In some cases, user interface component(s) 2425 include a GUI.

FIG. 25 shows an example of an image generation apparatus 2500 according to aspects of the present disclosure. Image generation apparatus 2500 is an example of, or includes aspects of, the corresponding element described with reference to FIGS. 1, 3, 4, 6, 18-22, and 24. Image generation apparatus 2500 may include an example of, or aspects of, the guided diffusion model described with reference to FIG. 10 and the U-Net described with reference to FIG. 11. In some embodiments, image generation apparatus 2500 includes processor unit 2505, memory unit 2510, image refinement model 2515, I/O module 2520, and training component 2525. Training component 2525 updates parameters of the image refinement model 2515 stored in memory unit 2510. In some examples, the training component 2525 is located outside the image generation apparatus 2500.

Processor unit 2505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 2505 is configured to operate a memory array using a memory controller. In other cases, a memory controller is integrated into processor unit 2505. In some cases, processor unit 2505 is configured to execute computer-readable instructions stored in memory unit 2510 to perform various functions. In some aspects, processor unit 2505 includes special purpose components for modem processing, baseband processing, digital signal processing, or transmission processing. According to some aspects, processor unit 2505 comprises one or more processors 2405 described with reference to FIG. 24.

Memory unit 2510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 2505 to perform various functions described herein.

In some cases, memory unit 2510 includes a basic input/output system (BIOS) that controls basic hardware or software operations, such as an interaction with peripheral components or devices. In some cases, memory unit 2510 includes a memory controller that operates memory cells of memory unit 2510. For example, the memory controller may include a row decoder, column decoder, or both. In some cases, memory cells within memory unit 2510 store information in the form of a logical state. According to some aspects, memory unit 2510 is an example of the memory subsystem 2410 described with reference to FIG. 24.

According to some aspects, image generation apparatus 2500 uses one or more processors of processor unit 2505 to execute instructions stored in memory unit 2510 to perform functions described herein. For example, the image generation apparatus 2500 may perform operations comprising obtaining a detail image and a style image, wherein the detail image depicts an image element and the style image depicts a style element; generating a combined image embedding including a detail embedding patch and a style embedding patch based on the detail image and the style image, wherein the detail embedding patch represents the image element and the style embedding patch represents the style element; and generating, using an image refinement model, a combined image based on the combined image embedding, wherein the combined image depicts the image element from the detail image and the style element from the style image.

The memory unit 2510 may include an image refinement model 2515 trained to generate a synthetic image based on an image embedding. For example, after training, the image refinement model 2515 may perform inferencing operations as described with reference to FIGS. 14 and 15 to generate a combined image based on the combined image embedding, wherein the combined image depicts the image element from the first region of the detail image and the style element from the third region of the style image. Image refinement model 2515 is an example of, or includes aspects of, the corresponding element described with reference to FIGS. 1, 3, and 18.

In some embodiments, the image refinement model 2515 is an artificial neural network (ANN) such as the guided diffusion model described with reference to FIG. 10 and the U-Net described with reference to FIG. 11. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the image refinement model 2515 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 2525 may train the image refinement model 2515. For example, parameters of the image refinement model 2515 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 16-18). The goal of the training process may be to find optimal values for the parameters that allow the image refinement model 2515 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image refinement model 2515 can be used to make predictions on new, unseen data (i.e., during inference).

I/O module 2520 receives inputs from and transmits outputs of the image generation apparatus 2500 to other devices or users. For example, I/O module 2520 receives inputs for the image refinement model 2515 and transmits outputs of the image refinement model 2515. According to some aspects, I/O module 2520 is an example of the I/O interface 2420 described with reference to FIG. 24.

According to some aspects, training component 2525 comprises executable code (e.g., software) stored in memory unit 2510, firmware, one or more hardware circuits, or a combination thereof.

Accordingly, a system and an apparatus for image generation are described. One or more aspects of the system and apparatus include a memory component and a processing device coupled to the memory component, the processing device configured to perform operations comprising: obtaining a detail image and a style image, wherein the detail image depicts an image element and the style image depicts a style element; generating a combined image embedding including a detail embedding patch and a style embedding patch based on the detail image and the style image, wherein the detail embedding patch represents the image element and the style embedding patch represents the style element; and generating, using an image refinement model, a combined image based on the combined image embedding, wherein the combined image depicts the image element from the detail image and the style element from the style image.

Some examples of the system and apparatus further include an image encoder configured to encode the detail image and the style image. Some example of the system and apparatus further include an image generation model trained to generate a synthetic image using the combined image as training data. Some examples of the system and apparatus further include a view generation model trained to generate a revised image based on the combined image, wherein the revised image depicts the image element from a different view than the combined image.

The description and drawings described herein represent example configurations and do not represent all the implementations within the scope of the claims. For example, the operations and steps may be rearranged, combined, or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image generation, comprising:
obtaining a detail image and a style image, wherein the detail image depicts an image element and the style image depicts a style element;
generating a combined image embedding including a detail embedding patch and a style embedding patch based on the detail image and the style image, wherein the detail embedding patch represents the image element and the style embedding patch represents the style element; and
generating, using an image refinement model, a combined image based on the combined image embedding, wherein the combined image depicts the image element from the detail image and the style element from the style image.

2. The method of claim 1, wherein obtaining the style image comprises:
obtaining a text prompt describing the style element; and
generating the style image based on the text prompt.

3. The method of claim 1, wherein:
the detail image includes a first region depicting the image element, the style image includes a second region depicting a corresponding image element and a third region depicting a style element, the detail embedding patch corresponds to the second region of the style image and represents the image element from the first region of the detail image based on a similarity between the image element and the corresponding image element, and the style embedding patch corresponds to the third region of the style image and represents the style element.

4. The method of claim 1, wherein generating the combined image embedding comprises:
encoding the detail image and the style image to obtain a detail embedding and a style embedding, respectively; and
dividing the detail embedding and the style embedding into a plurality of detail embedding patches and a plurality of style embedding patches, respectively, wherein the combined image embedding is based on the plurality of detail embedding patches and the plurality of style embedding patches.

5. The method of claim 4, wherein generating the combined image embedding comprises:
computing a plurality of similarity scores between the style embedding patch and the plurality of detail embedding patches, respectively;
selecting the detail embedding patch as corresponding to the style embedding patch based on the detail embedding patch having a highest similarity score among the plurality of similarity scores; and
computing a combined patch embedding based on the detail embedding patch and the style embedding patch, wherein the combined image embedding includes the combined patch embedding at an index of the style embedding patch.

6. The method of claim 1, further comprising:
using the combined image as training data for training an image generation model to generate a synthetic image.

7. The method of claim 6, wherein:
the image generation model is trained by generating a revised image as training data based on the detail image.

8. The method of claim 1, wherein:
the image refinement model is trained to generate a synthetic image based on an image embedding.

9. A non-transitory computer readable medium storing code for image generation, the code comprising instructions that, when executed by at least one processor, cause the at least one processor to perform operations comprising:
obtaining a detail image and a text prompt;
generating, using an image generation model, a style image based on the text prompt;
generating a combined image embedding including a detail embedding patch and a style embedding patch based on the detail image and the style image, respectively; and
generating, using an image refinement model, a combined image based on the combined image embedding.

10. The non-transitory computer readable medium of claim 9, wherein:
the detail image includes a first region depicting an image element;
the style image includes a second region depicting a corresponding image element and a third region depicting a style element;
the detail embedding patch corresponds to the second region of the style image and represents the image element from the first region of the detail image based on a similarity between the image element and the corresponding image element;
the style embedding patch corresponds to the third region of the style image and represents the style element; and
the combined image depicts the image element from the first region of the detail image and the style element from the third region of the style image.

11. The non-transitory computer readable medium of claim 10, wherein:
the style image is generated based on the detail image in addition to the text prompt.

12. The non-transitory computer readable medium of claim 9, wherein generating the combined image embedding comprises:
encoding the detail image and the style image to obtain a detail embedding and a style embedding, respectively; and
dividing the detail embedding and the style embedding into a plurality of detail embedding patches and a plurality of style embedding patches, respectively, wherein the combined image embedding is based on the plurality of detail embedding patches and the plurality of style embedding patches.

13. The non-transitory computer readable medium of claim 12, wherein generating the combined image embedding comprises:
computing a plurality of similarity scores between the style embedding patch and the plurality of detail embedding patches, respectively;
selecting the detail embedding patch as corresponding to the style embedding patch based on the detail embedding patch having a highest similarity score among the plurality of similarity scores; and
computing a combined patch embedding based on the detail embedding patch and the style embedding patch, wherein the combined image embedding includes the combined patch embedding at an index of the style embedding patch.

14. The non-transitory computer readable medium of claim 9, wherein the instructions further cause the at least one processor to perform operations comprising:
training an image generation model to generate a synthetic image using the combined image as training data.

15. The non-transitory computer readable medium of claim 14, wherein the instructions further cause the at least one processor to perform operations comprising:
generating a revised image based on the detail image, wherein the revised image depicts an image element from a different view than the detail image; and
training the image generation model to generate the synthetic image using the revised image as training data.

16. The non-transitory computer readable medium of claim 9, wherein:
the image refinement model is trained to generate a synthetic image based on an image embedding.

17. A system comprising:
a memory component; and
a processing device coupled to the memory component, the processing device configured to perform operations comprising:
obtaining a detail image and a style image, wherein the detail image depicts an image element and the style image depicts a style element;
generating a combined image embedding including a detail embedding patch and a style embedding patch based on the detail image and the style image, wherein the detail embedding patch represents the image element and the style embedding patch represents the style element; and
generating, using an image refinement model, a combined image based on the combined image embedding, wherein the combined image depicts the image element from the detail image and the style element from the style image.

18. The system of claim 17, further comprising:
an image encoder configured to encode the detail image and the style image.

19. The system of claim 17, further comprising:
an image generation model trained to generate a synthetic image using the combined image as training data.

20. The system of claim 17, further comprising:
a view generation model trained to generate a revised image based on the combined image, wherein the revised image depicts the image element from a different view than the combined image.
